(19) United States
(12) Patent Application Publication
(10) Pub. No.: US 2026/0200570 A1
(43) Pub. Date: Jul. 16, 2026

(54) ELECTRIC MOTORIZED WATERCRAFT

(71) Applicant: Ride Awake ApS, København K (DK)

(72) Inventor: Philip WERNER, Stockholm (SE)

(73) Assignee: Ride Awake ApS, København K (DK)

(21) Appl. No.: 19/136,970

(22) PCT Filed: Dec. 14, 2023
(86) PCT No.: PCT/SE2023/051256

§ 371 Date: Jun. 9, 2025

(30) Foreign Application Priority Data
Dec. 14, 2022 (SE) 2251455-8

(51) Int. Cl. B63H 21/17; B63B 34/10; B63B 79/10; B63B 79/40; B63H 21/21; B63H 25/42; G08G 3/02

(52) U.S. Cl. CPC B63H 21/17; B63B 34/10; B63B 79/10; B63B 79/40; B63H 21/21; B63H 25/42; G08G 3/02; B63B 2213/02; B63H 2021/216

(57) ABSTRACT

A modular electrically motorized watercraft may include a hull module and a driveline system. The driveline system may include one or more electric power modules and two or more driveline modules. The two or more driveline modules may be configured to be mounted to an underside of the hull module. The modules may constitute independent sub-assemblies that form the watercraft when assembled together.

### TECHNICAL FIELD

The present invention relates to watercrafts. In particular the invention relates to an electrical motor driven watercraft system, more in particular a modular electric motor driven watercraft system.

### BACKGROUND

There are only a small amount of existing electrical watercrafts on the market. There exists different solutions on how the motor is mounted on the watercraft. Some are integrated some are detachable. Furthermore, there exists different setups with integrated or detachable batteries.

Recently, electrical watercrafts in the form of motorized surfboards has gained popularity. Although being easily transportable and relatively light, they require the user to be experienced and knowledgeable due to being steered only be means of the body weight.

Watercrafts allowing for other means of steering and/or allows for additional comfort for the user during operation are often bulky and complex as well as difficult to transport.

### SUMMARY

One technical benefit of the present disclosure is that a simple watercraft solution which enables a higher level of modularity than existing solutions may be provided.

One technical benefit of the present disclosure is that a watercraft solution allowing for easy transportation may be provided.

One technical benefit of the present disclosure is that a watercraft solution which is easy steer and maneuver may be provided.

These objects and further objects, which will appear from the following description, have now been achieved by the technique set forth in the appended independent claims; preferred embodiments being defined in the related dependent claims.

According to one aspect of the disclosure, a modular electrically motorized watercraft is provided. The watercraft may comprise a hull module and a driveline system. The driveline system may comprise one or more electric power modules and two or more driveline modules. The two or more driveline modules may be configured to be mounted to an underside of the hull module. The modules may constitute independent sub-assemblies in the form of modules which can be assembled to form said watercraft.

The hull module may comprise one or more compartments. The one or more compartments may be adapted to receive at least one of the one or more electric power modules. Thereby, a modularized watercraft which is easier to assemble is achieved.

In one example, a first electric power module may be connected to a first driveline module to form a first driveline arrangement. A second electric power module may be connected to a second driveline module to form a second driveline arrangement. Thereby, the components of the watercraft may be assembled in a fast and user-friendly manner.

In one example, at least one of the driveline modules may comprise a jet drive for propelling the watercraft. In one example, at least one of the driveline modules may comprise a propeller drive for propelling the watercraft.

In one example, the watercraft may further comprise one or more hydrofoil arrangements connected to the hull module and configured to be arranged below the underside of the hull module. The one or more hydrofoil arrangements may allow for the watercraft to hydrofoil at high speeds, reducing the resistance from the water and the power consumption of the watercraft. Another benefit may be that the one or more hydrofoil arrangement allows for a modularized watercraft enabling hydrofoiling.

In one example, the driveline modules may be adapted to be mounted to said one or more hydrofoil arrangements. This further enhances the modularity as the driveline modules may be pre-mounted to the hydrofoil arrangements prior to mounting of the hydrofoil arrangements to the hull module.

In one example, at least one of the one or more hydrofoil arrangements may comprise one or more masts connecting a hydrofoil portion of the hydrofoil arrangement to the hull body. The masts allow for easy mounting to the hull module and ensures a predictable behavior during hydrofoiling due to providing a set distance between the hydrofoil portion of the hydrofoil arrangement and the underside of the hull module.

In one example, the hydrofoil portion of the at least one of the one or more hydrofoil arrangements may comprise at least one hydrofoil wing. The at least one hydrofoil wing may provide an additional surface for bearing the watercraft in addition to the hull module, i.e. the underside of the hull module.

In one example, at least one of the one or more hydrofoil arrangements may be detachably connected to the hull module. Hence, the watercraft may be modularly equipped with hydrofoil arrangements to selectively enable the hydrofoiling functionality.

In one example, at least one of the one or more masts may be connected to the hull module by means of a pivot connection such that said at least one mast may be movable relative the hull module between a deployed position and a stowed away position. Thus, masts may be folded in during transportation, allowing for easier transport.

In one example, the driveline modules may comprise a connection interface adapted to be mountable both directly to the hull module and to the one or more hydrofoil arrangements. Hence, the modularity of the watercraft is further improved due to a user being able to use the same driveline modules for mounting directly to the hull module as well as to a hydrofoil arrangement depending on the circumstances.

In one example, the one or more mast of at least one of the one or more hydrofoil arrangements may be adjustably connected to the hull module such that the distance between the hydrofoil portion of the hydrofoil arrangement and the hull module is adjustable. Thereby a user may adjust the depth of the hydrofoil portion depending on how the watercraft is intended to be used and based on present conditions of the watercraft and the surrounding environment such as the depth of water in which the watercraft is operated and the speed at which the user is intending to operate the watercraft.

In one example, at least one of the one or more hydrofoil arrangement may comprise a hydrofoil wing directly mounted to the hull module.

In one example, the one or more driveline modules may be adapted to be mounted directly to the hull module. Thus, the watercraft may be utilized as a normal watercraft without any hydrofoiling properties. In one example, the one or more driveline modules may be arranged at a rear portion of the hull module and the hydrofoil wing may be arranged at a front portion of the hull module.

In one example, at least one of the one or more hydrofoil arrangements may comprise a movable wing. The movable wing may be connected to a regulating member for regulating the position of the movable wing. Thereby, the position of the wing may be regulated in order to guide movement of the watercraft towards a hydrofoiling state.

In one example, the hull module may further comprise an outboard connection arrangement adapted to provide a releasable mounting for one or more outboard propeller motor system or outboard jet motor system for propelling the watercraft. Hence, a watercraft with a further improved modularity is achieved.

In one example, the driveline system may be operable independently from the hull module.

In one example, the hull module may form any one of a flat hull, a catamaran hull, a trimaran hull or a V-shaped hull.

In one example, the hull module may comprise at least one inflatable hull component.

In one example, the hull module may comprise a rigid support structure and the at least one inflatable hull component may be connected to the rigid support structure.

In one example, the watercraft may further comprise a seating portion for accommodating a seated driver of the watercraft. Thus, a modular watercraft which is more comfortable to drive is achieved. Further, the seating portion makes the watercraft easier to use for an inexperienced user.

In one example, the watercraft may further comprise a handle for accessing the watercraft from the water. A benefit may include that the user is provided with assistance for climbing on top of the watercraft from the water.

In one example, wherein the hull module extends along a longitudinal center axis, the driveline modules may comprise at least one first driveline module arranged on a first side of the longitudinal center axis and at least one second driveline module arranged on a second side of the longitudinal center axis. The distribution of the driveline modules allows for predictable and stable propulsion of the watercraft.

In one example, the watercraft may be configured to be steerable by means of the body weight of a user. Hence, movable steering members such as rudders may be avoided, making the watercraft lighter and less complex and easier to transport.

In one example, the watercraft may be configured to be steerable by means of individual speed control of the driveline modules. Hence, movable steering members such as rudders may be avoided, making the watercraft lighter and less complex.

In one example, the watercraft may further comprise one or more controlling units configured to cause control of the speed of at least one driveline module based on user input data obtained from a user interface of said one or more controlling units.

In one example, the watercraft may further comprise a first controlling unit configured to cause control of the speed of the at least one first driveline module based on user input data obtained from the user interface of the first controlling unit and a second controlling unit configured to cause control the speed of the at least one second driveline module based on user input data obtained from the user interface of the second controlling unit. Thereby, the watercraft may be steered and maneuvered by means of a user independently operating the first and second controlling unit. A benefit may include that such steering is intuitive and user friendly. Another benefit may include that such steering is particularly advantageous when the watercraft operates at lower speeds as it allows for sufficient turning also in such conditions.

In one example, the watercraft may comprise a steering element. The one or more controlling unit and the steering element may be configured to cause individual control of the speed of the at least one first driveline module and the at least one second driveline module based on the user input data obtained from the user interface of the controlling unit and the position of the steering element. Thus, an intuitive steering may of the watercraft (mimicking a conventional boat or jetski) may achieved without requiring movable rudders or similar for the steering.

In one example, the steering element may be detachable and the driveline system may be operable without said steering element. Hence, the modularity of the watercraft is further improved due to it being possible for a user to remove the steering element to reduce weight and make transportation easier and also operate the watercraft without the steering element if desired.

In one example, the watercraft may comprise a control system configured to control the operation of the watercraft and to be operatively connected to the driveline modules and the one or more electric power modules.

In one example, the one or more controlling units may be operatively connected to the control system to enable data communication between the one or more controlling units and the control system. The data communication allows for intelligent control of the watercraft based on the input received by the controlling units.

In one example, the control system may comprise one or more power controller. The power controller may be configured to control at least one of the one or more electric power modules. The provision of the power controller(s) improves the modularity of the watercraft due to the power controller enabling separate control functionality for the one or more electric power modules.

In one example, the control system may comprise one or more drive controllers. The one or more drive controllers may be configured to control at least one of the driveline modules. The provision of the drive controller(s) improves the modularity of the watercraft due to the drive controller enabling separate control functionality for the one or more driveline module.

In one example, at least one of the one or more drive controllers may be disposed in one of the one or more mast. This allows for passive cooling of the drive controller by air or water during operation depending on if the watercraft is hydrofoiling or not.

In one example, at least one of the one or more drive controllers may be disposed in one of the driveline modules. Thus, the control functionality as well as the propulsion function may be integrated into one module, whereby the modularity of the watercraft is improved.

In one example, at least one of the one more drive controllers may be disposed adjacent to the underside of the hull module. This allows for the water to passively cool the one or more drive controllers during operation.

In one example, the control system may be configured to obtain control data from an external device and cause control of the watercraft based on the control data. Thus, the watercraft may be operated from a distance. In one example, the control system may be configured to obtain the control data from an external device via a wireless network for controlling the operation of the watercraft.

In one example, the control system may be configured to cause steering and propelling of the watercraft based on the obtained control data. Thus, the operation of the watercraft may be controlled from a remote position. For example, a user may select a drive mode or start and stop the watercraft from a remote position.

In one example, the control data may comprises location data. The control system may be configured to cause the watercraft to autonomously travel to a determined location based on said location data. Thus a user may for example cause the watercraft to travel to a set location for docking or to the location of the user.

In one example, the watercraft may comprise one or more positional sensing device, such as a camera, radar or GPS-device, operatively connected to the control system and configured to acquire positional data associated with the position of the watercraft and/or to acquire data indicating potential obstacles along the route of the watercraft. A benefit may include that the risk for the watercraft colliding with an object during operation for example during autonomous operation. Thus, in one example, the control system may be configured to cause steering and propelling of the vehicle based on the obtained positional data and/or data indicating potential obstacles along the route of the watercraft.

In one example, the watercraft may comprise one or more height sensor operatively connected to the control system and configured to obtain height data associated with the height of the watercraft relative the water surface, whereby the control system is configured to control the operation of the watercraft based on said height data. This is particularly advantageous in the case of the watercraft being operated as a hydrofoiling watercraft as the resistance may vary greatly depending on the height of the watercraft relative the water.

According to one aspect of the disclosure, a modular electrically motorized watercraft is provided. The watercraft may comprise a hull module and a driveline system. The driveline system may comprise one or more electric power modules and one or more driveline modules. The one or more driveline modules may be configured to be mounted to an underside of the hull module. The modules may constitute independent sub-assemblies in the form of modules which can be assembled to form said watercraft. The watercraft may comprise a seating portion for accommodating a seated driver of the watercraft. Thus, a modular watercraft which is more comfortable to drive is achieved. Further, the seating portion makes the watercraft easier to use for an inexperienced user.

In one example, the driveline system may comprise two or more modules. The plurality of driveline modules may allow for an increased modularity as well as allowing for the use of smaller driveline modules, making the watercraft easier to transport. The plurality of driveline modules may allow for a better distribution of the propelling forces of the watercraft, making the watercraft more stable during operation.

The hull module may comprise one or more compartments. The one or more compartments may be adapted to receive at least one of the one or more electric power modules. Thereby, a modularized watercraft which is easier to assemble is achieved.

In one example, a first electric power module may be connected to a first driveline module to form a first driveline arrangement. A second electric power module may be connected to a second driveline module to form a second driveline arrangement. Thereby, the components of the watercraft may be assembled in a fast and user-friendly manner.

In one example, the watercraft may further comprise one or more hydrofoil arrangements connected to the hull module and configured to be arranged below the underside of the hull module. The one or more hydrofoil arrangements may allow for the watercraft to hydrofoil at high speeds, reducing the resistance from the water and the power consumption of the watercraft. Another benefit may be that the one or more hydrofoil arrangement allows for a modularized watercraft enabling hydrofoiling.

In one example, the one or more driveline modules may be adapted to be mounted to said one or more hydrofoil arrangements. This further enhances the modularity as the driveline modules may be pre-mounted to the hydrofoil arrangements prior to mounting of the hydrofoil arrangements to the hull module.

In one example, at least one of the one or more hydrofoil arrangements may comprise one or more masts connecting a hydrofoil portion of the hydrofoil arrangement to the hull body. The masts allow for easy mounting to the hull module and ensures a predictable behavior during hydrofoiling due to providing a set distance between the hydrofoil portion of the hydrofoil arrangement and the underside of the hull module.

In one example, the hydrofoil portion of the at least one of the one or more hydrofoil arrangements may comprise at least one hydrofoil wing. The at least one hydrofoil wing may provide an additional surface for bearing the watercraft in addition to the hull module, i.e. the underside of the hull module.

In one example, at least one of the one or more hydrofoil arrangements may be detachably connected to the hull module. Hence, the watercraft may be modularly equipped with hydrofoil arrangements to selectively enable the hydrofoiling functionality.

In one example, at least one of the one or more masts may be connected to the hull module by means of a pivot connection such that said at least one mast may be movable relative the hull module between a deployed position and a stowed away position. Thus, masts may be folded in during transportation, allowing for easier transport.

In one example, the driveline modules may comprise a connection interface adapted to be mountable both directly to the hull module and to the one or more hydrofoil arrangements. Hence, the modularity of the watercraft is further improved due to a user being able to use the same driveline modules for mounting directly to the hull module as well as to a hydrofoil arrangement depending on the circumstances.

In one example, the one or more mast of at least one of the one or more hydrofoil arrangements may be adjustably connected to the hull module such that the distance between the hydrofoil portion of the hydrofoil arrangement and the hull module is adjustable. Thereby a user may adjust the depth of the hydrofoil portion depending on how the watercraft is intended to be used and based on present conditions of the watercraft and the surrounding environment such as the depth of water in which the watercraft is operated and the speed at which the user is intending to operate the watercraft.

In one example, at least one of the one or more hydrofoil arrangements may comprise a movable wing. The movable wing may be connected to a regulating member for regulating the position of the movable wing. Thereby, the position of the wing may be regulated in order to guide movement of the watercraft towards a hydrofoiling state.

In one example, the hull module may further comprise an outboard connection arrangement adapted to provide a releasable mounting for one or more outboard propeller motor system or outboard jet motor system for propelling the watercraft. Hence, a watercraft with a further improved modularity is achieved.

In one example, the hull module may form any one of a flat hull, a catamaran hull, a trimaran hull or a V-shaped hull.

In one example, the watercraft may comprise an operations module. The operations module may be adapted to be detachably mounted to the hull module. The operations module may comprise the seating portion. This allows for the seating portion to be detached from the hull module allowing for easier transportation. It may also allow for operation of the watercraft without the seating portion, further improving the modularity of the watercraft.

In one example, the watercraft may further comprise a handle for accessing the watercraft from the water. A benefit may include that the user is provided with assistance for climbing on top of the watercraft from the water.

In one example, the operations module may comprise the handle for accessing the watercraft from the water.

In one example, the watercraft may comprise a support structure. The support structure may be adapted to connect the hull module and the seating portion. The support structure may be adapted to provide a distance between an upper seating surface of the seating portion and the hull module. The support structure allows for additional comfort for the driver as it allows additional legroom when the driver is seated on the seating portion.

In one example, the support structure may be adapted to connect the operations module and the hull module. The support structure may be releasably connected to the operations module and/or the hull module. Thereby, the modularity of the watercraft is further improved due to the support structure allowing for the dismounting of the operations module from the hull module.

In one example, the support structure may be adjustable between a first position wherein the seating portion is elevated relative the hull module and a second position wherein the seating position is lowered relative the hull module. Such an adjustable support structure allows for easier transportation of the watercraft due to reducing the space required for the watercraft.

In one example, the hull module extends along a longitudinal center axis, whereby the driveline modules may comprise at least one first driveline module arranged on a first side of the longitudinal center axis and at least one second driveline module arranged on a second side of the longitudinal center axis. The distribution of the driveline modules allows for predictable and stable propulsion of the watercraft.

In one example, the watercraft may be configured to be steerable by means of the body weight of a user. Hence, movable steering members such as rudders may be avoided, making the watercraft lighter and less complex and easier to transport.

In one example, the watercraft may be configured to be steerable by means of individual speed control of the at least one first driveline module and the at least one second driveline module. Hence, movable steering members such as rudders may be avoided, making the watercraft lighter and less complex.

In one example, the watercraft may further comprise one or more controlling units configured to cause control of the speed of at least one driveline module based on user input data obtained from a user interface of said one or more controlling units.

In one example, the watercraft may further comprise a first controlling unit configured to cause control of the speed of the at least one first driveline module based on user input data obtained from the user interface of the first controlling unit and a second controlling unit configured to cause control the speed of the at least one second driveline module based on user input data obtained from the user interface of the second controlling unit. Thereby, the watercraft may be steered and maneuvered by means of a user independently operating the first and second controlling unit. A benefit may include that such steering is intuitive and user friendly. Another benefit may include that such steering is particularly advantageous when the watercraft operates at lower speeds as it allows for sufficient turning also in such conditions.

In one example, the watercraft may comprise a steering element. The one or more controlling unit and the steering element may be configured to cause individual control of the speed of the at least one first driveline module and the at least one second driveline module based on the user input data obtained from the user interface of the controlling unit and the position of the steering element. Thus, an intuitive steering may of the watercraft (mimicking a conventional boat or jetski) may achieved without requiring movable rudders or similar for the steering.

In one example, the steering element may be detachable and the driveline system may be operable without said steering element. Hence, the modularity of the watercraft is further improved due to it being possible for a user to remove the steering element to reduce weight and make transportation easier and also operate the watercraft without the steering element if desired.

In one example, the steering element may be detachably mounted to the operations module. Thereby, the modularity of the watercraft is further improved.

In one example, the one or more controlling units may be arranged on the operations module. Having the controlling units provided separate from the hull module and instead mounted to the operations module allows for easier transportation of the watercraft due to the hull module not having to include any bulky vertically protruding elements that complicates transport of the watercraft.

In one example, the watercraft may comprise a control system configured to control the operation of the watercraft and to be operatively connected to the driveline modules and the one or more electric power modules.

The above examples are by not to be construed as limiting the invention, rather, embodiments and aspects may be combined to yield yet further embodiments.

Further advantages and aspects are described below and set forth in the appended claims.

### BRIEF DESCRIPTION OF DRAWINGS

Embodiments of the invention will be described in further detail below in the shape of non-limiting examples and with reference to the accompanying drawings, in which:

FIG. 1a shows a perspective view of the watercraft according to one example.

FIG. 1b shows a perspective view of the watercraft according to the example of FIG. 1a with a user.

FIG. 1c shows a perspective view of the watercraft according to the example of FIG. 1a with a single electric power module.

FIG. 1d shows a perspective view of a driveline module of the watercraft according to one example.

FIG. 2 shows an explosion view of the watercraft according to the example of FIG. 1a.

FIG. 3 shows an explosion view of the watercraft according one example.

FIG. 4 shows an explosion view of the watercraft according to one example.

FIG. 5 shows a bottom view of the watercraft according to one example.

FIG. 6 shows a bottom perspective view of the watercraft according to one example.

FIG. 7 shows a top perspective view of the watercraft according to one example.

FIG. 8 shows a top perspective view of parts of the watercraft according to one example.

FIG. 9 shows a bottom perspective view of parts of the watercraft according to one example.

FIG. 10 shows a bottom perspective view of parts of the watercraft according to one example.

FIG. 11 shows a partial cross-section side view of the watercraft according to one example.

FIG. 12 shows a perspective view of parts of the watercraft according to one example.

FIG. 13a shows a perspective bottom view of parts of the watercraft according to one example.

FIG. 13 shows a side view of parts of the watercraft according to one example.

FIG. 14 shows a side view of parts of the watercraft according to one example.

FIG. 15 shows a side view of the watercraft according to one example.

FIG. 16 shows a side view of parts of the watercraft according to one example.

FIG. 17 shows a perspective view of parts of the watercraft according to one example.

FIG. 18 shows a perspective view of the watercraft according to one example.

FIG. 19 shows a perspective view of parts of the watercraft according to one example.

FIG. 20 shows a perspective view of the watercraft according to one example.

FIG. 21 shows a perspective view of the watercraft according to one example.

FIG. 22 shows a perspective view of the watercraft according to one example.

FIG. 23 shows a perspective view of the watercraft according to one example.

FIG. 24 shows a perspective view of the watercraft according to one example.

FIG. 25 shows a perspective view of the watercraft according to one example.

FIG. 26 shows a perspective view of the watercraft according to one example.

FIG. 27 shows a side view of the watercraft according to one example.

FIG. 28 shows a side view of the watercraft according to one example.

FIG. 29 shows a perspective view of the watercraft according to one example.

FIG. 30 shows a perspective view of the watercraft according to one example.

FIG. 31 shows a perspective view of the watercraft according to one example.

FIG. 32 shows a back view of the watercraft according to one example.

FIG. 33a-c shows a different views of the watercraft according to one example.

FIG. 34 shows a schematic view of the watercraft according to one example.

### DETAILED DESCRIPTION

The invention will now be explained with reference to the accompanying drawings.

According to an aspect of this disclosure, a watercraft 10 is provided.

The watercraft may be a modular electrically motorized watercraft 10. The watercraft 10 may comprise a hull module 20.

The watercraft 10 may comprise a driveline system. The driveline system may comprise one or more electric power modules 50. The driveline system may comprise one or more driveline modules 30.

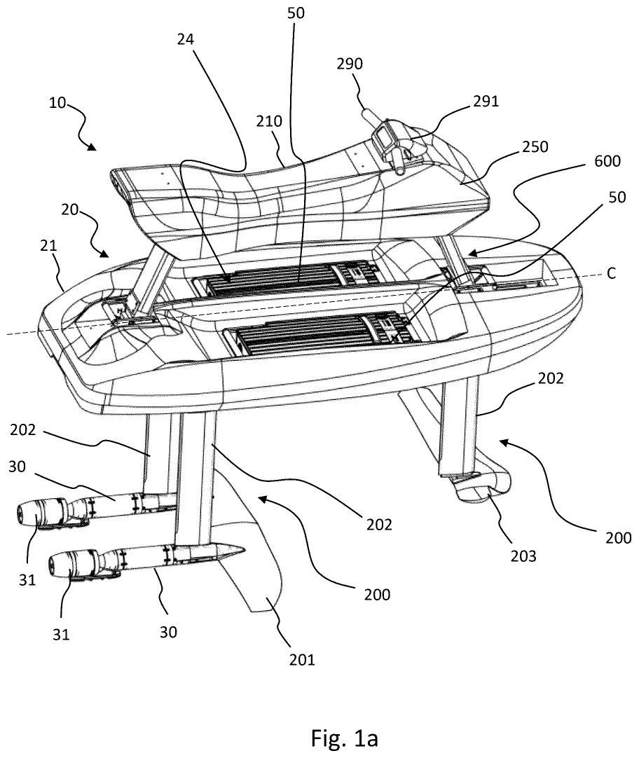

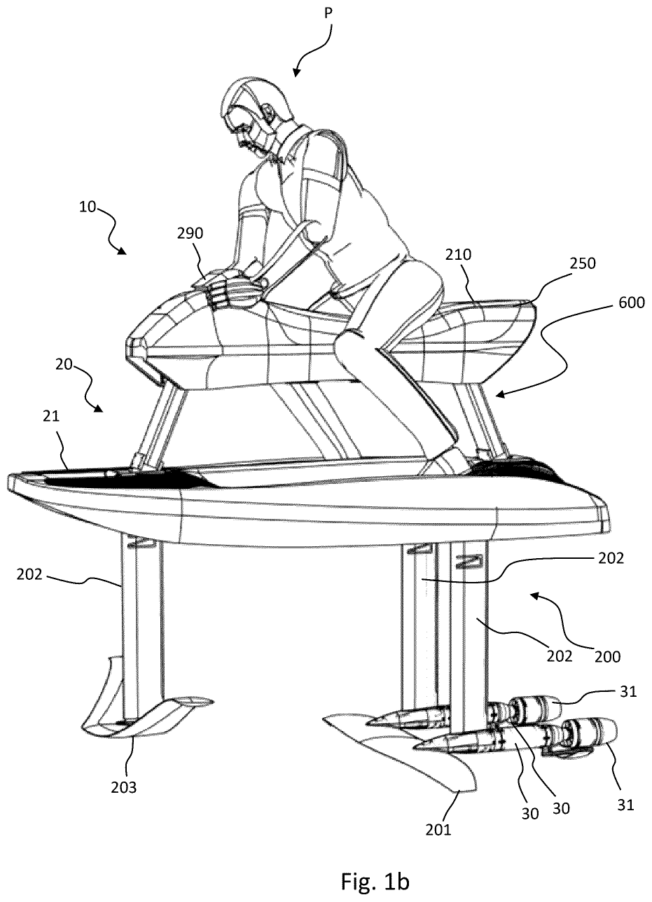

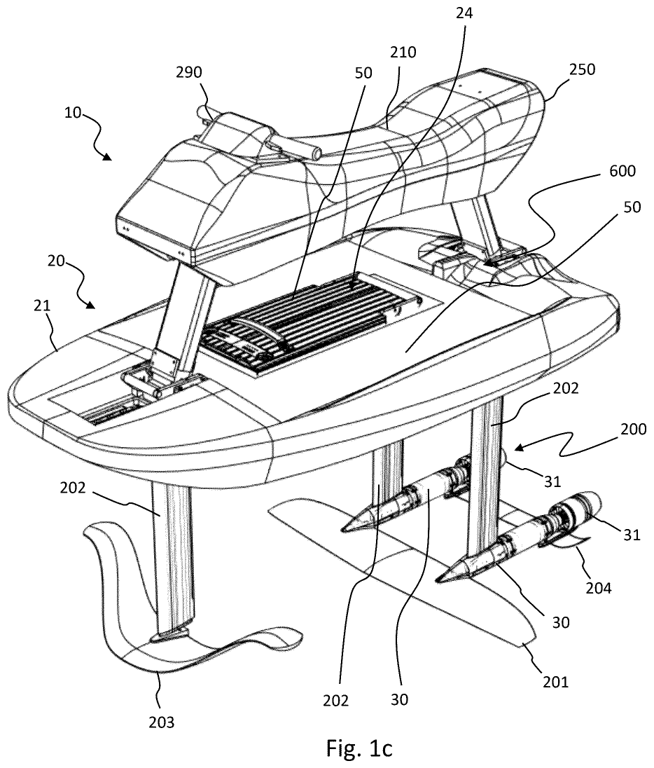

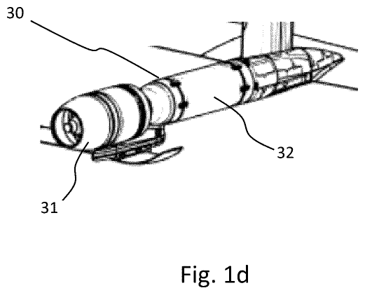

As will be described with reference to FIGS. 1-32, the driveline modules may be configured to be mounted to an underside of the hull module 20. An underside herein refers to a bottom surface of the hull module 20. As will be described, the one or more driveline modules 30 may be configured to be mounted to the underside of the hull module 20 either by means of being directly connected to the hull module 20 or by means of being connected to the hull module 20 via a hydrofoil arrangement.

It may however be envisioned that the driveline modules are simply mounted to the hull module. Thus, according to one example of the disclosure, the one or more driveline modules may be configured to be mounted to the hull module 20.

The modules 20, 30, 50, i.e. the hull module 20, the one or more electric power modules 50 and the one or more driveline modules 30 may constitute independent sub-assemblies in the form of modules which can be assembled to form the watercraft 10.

The modules may be individual parts. Substantially the entire driveline module may be submerged in a surrounding fluid during operation of the watercraft. The modules may constitute independent sub-assemblies in the form of modules which can be assembled to a fully functional watercraft. No electrical parts may be integrated in the hull module. All necessary electrical components may be integrated in the driveline system.

One or more of the modules may be independent sub-assemblies and/or independent parts where each independent sub-assembly has its individual housing.

In one example, the driveline system may comprise two or more driveline modules 30 in accordance with the examples of FIG. 1a-1c.

The one or more driveline modules 30 may be configured to cause propulsion of the watercraft 10.

The one or electric power modules 50 may be configured to power the one or more driveline modules 30. The one or more electric power modules 50 may be considered the energy source(s) of the watercraft 10. The one or more electric power modules may comprise electronics for powering the driveline modules 30 and potentially other components of the watercraft 10. Thus, the one or more electric power modules may comprise battery cells, a computing device, battery management system, switches etc. The composition of electronics can vary. The electric power module may be designed in any material.

Referencing FIG. 1a, the hull module 20 may extend along a longitudinal center axis C. The hull module 20 may comprise front portion and a rear portion relative the longitudinal center axis C.

The hull module 20 may comprise a flotation body 21 intended to provide a surface adapted to engage the water surface to cause the watercraft 10 to float. As will be described further on, additional surfaces for engaging the water may be introduced in the form of hydrofoil arrangements.

Depending on the application of the watercraft, a number of variants of hull shapes maybe utilized. For example, a user may have a set of various hull modules available and may kit the selected watercraft with a set of electric power modules and driveline modules accordingly. The hull module 20 may for example form any one of a flat hull, a catamaran hull, a trimaran hull or a V-shaped hull.

It may also be envisioned that the hull module 20 is at least partially inflatable. Accordingly, the hull module 20 may comprise at least one inflatable hull component. Advantageously, the hull module 20 may comprise a rigid support structure, whereby the at least one inflatable hull component 20 may be connected to said rigid support structure. Preferably, the one or more electric power module 20 and/or the one or more driveline modules 30 may be configured to be mounted to the rigid support structure. Accordingly, the rigid support structure may comprise any of the herein described means for mounting of the one or more electric power module 20 and/or the one or more driveline modules 30. In one example, the at least one inflatable hull component may form at least a part of the flotation body 21. In one example, the at least one inflatable hull component may form the entirety of the flotation body. In one example, the at least one inflatable hull component may be arranged to at least partially envelop the rigid support structure, thereby forming at least a part of an outer rim of the hull module 20.

The hull module 20 comprises means for receiving the one or more electric power modules 50 here in the form of one or more compartments 24 facilitating that an electric power module 50 is safely received and retained in the hull module 20 without risk of dislodging during operation of the watercraft 10.

The electric power module 50 may comprise a shape corresponding to an external surface, such as the top-part of the hull module and thus become flush with edges of the hull module 20 and/or compartment 24 upon attachment to the hull module 20/compartment 24. Attachment means may be provided in the hull module 20 and/or on the electric power module 50 for detachable attachment of the electric power module 50 to the hull module 20. The attachment means may according to one example comprise releasable attachment means, such as a snap-in function.

The compartment 24 thus constitutes an external surface of the hull module 20 which may abut the electric power module 50. Preferably, the electric power module 50 is disposed flush with an upper surface of the hull module 20 when the electric power module 50 is received in the hull module 20.

The hull module 20 may hence comprise the one or more compartments 24. The one or more compartments 24 may be adapted to receive at least one of the one or more electric power modules 50.

In the example of FIG. 1a, the hull module 20 comprises two compartments 24. A first compartment 24 may be adapted to receive a first electric power module 50 and a second compartment 24 may be adapted to receive a second electric power module 50.

It may however also be envisioned that one compartment 24 may be adapted to receive multiple electric power modules 50.

In one example, one or more electric power modules 50 may be mounted to the hull module 20 by means of fixation to the hull module 20. The one or more electric power module 50 may be mounted on top of the hull module 20.

As seen in FIG. 1a, a first electric power module 50 may be connected to a first driveline module 30 to form a first driveline arrangement. A second electric power module 50 may be connected to a second driveline module 30 to form a second driveline arrangement. Preferably, the first and second driveline arrangement may be independently operable.

In one example, the driveline modules may comprise at least one first driveline module 30 arranged on a first side of the longitudinal center axis C. In one example, the driveline modules may comprise at least one second driveline module arranged on a second side of the longitudinal center axis C.

In one example, the first driveline arrangement may be arranged on a first side of the longitudinal center axis C and the second driveline arrangement may be arranged on a second side of the longitudinal center axis C. It may however also be envisioned that the at least one of the first and second driveline modules are connected to the same electric power module or that said at least one of the first and second driveline modules each is connected to a plurality of electric power modules.

In the example depicted in FIG. 1a, the driveline modules 30, i.e. the first and second driveline module 30, each comprise a jet drive 31.

In one example, a torpedo type of driveline module may be utilized. A torpedo type of driveline module may include all of the components for powering the driveline module and propelling the watercraft. Hence, the electric power module 50 and the driveline module 30 may be arranged in a driveline arrangement module. The watercraft 10 may thus comprise one or more driveline arrangement modules, each comprising one or more electric power module 50 and one or more driveline module 30. The one or more electric power module 50 may be configured to power the one or more driveline module 30.

As shown in FIG. 1a, the one or more driveline modules 30 may be configured to be mounted to the underside of the hull module 20 such that the one or more driveline modules 30 are at least partially submerged during operation, i.e. when the watercraft 10 is launched into water. In one example, substantially the entirety of the one or more driveline module 30 or the entirety of the one or more driveline modules 30 may be submerged during operation, i.e. when the watercraft 10 is launched into water.

During operation the water will provide passive water cooling to the driveline module 30 and in particular to the motor of the driveline module.

Accordingly, the one or more driveline modules 30 may be configured to be mounted to the underside of the watercraft 10 such that the one or more driveline module 30 is at least partially submerged in the water during operation of the watercraft 10 in the water, whereby the water provides passive cooling of said one or more driveline module 30. Preferably, the water provides passive cooling of a motor of said one or more driveline module 30 during said operation. In one example, the one or more driveline module 30 may be at least partially submerged in the water at least during movement of the watercraft 10 in a straight forward direction. The motor of the driveline module 30 will be described in further detail with reference to FIG. 1d.

In one embodiment, the watercraft 10 comprises two or more driveline modules 30. The two or more driveline modules 30 may be configured to be mounted to the underside of the watercraft 10 such that the two or more driveline modules 30 are at least partially submerged in the water during operation of the watercraft 10 in water, whereby the water provides passive cooling of each of said two or more driveline modules 30 during said operation.

At least partially submerged may herein refer to that at least a portion of the driveline module 30 is arranged to be positioned beneath the water surface during operation of the watercraft 10 in the water.

The electric power module 50 and the driveline module 30 may be detachably attached on opposite sides of said hull module 20. This facilitates that the power module 50 can easily be switched out for another power module for example when the batteries are depleted, and so without pivoting or turning the hull module 20, for example when floating on water.

The watercraft 10 may be steerable by means of the body weight of a user. The watercraft 10 may thus be steered by means of the user shifting the body weight. Thus, the watercraft 10 may be maneuverable by means of the user shifting the weight while operating the watercraft 10. It is noted that steerable by means of body weight herein does not exclude the possibility of other controllable means allowing for the steering of the watercraft 10. The watercraft 10 may thus be a considered a body-weight controlled watercraft 10 and/or a personal watercraft 10 such as a jetski or water scooter.

To reduce the power consumption as well as enable for a faster watercraft, the watercraft may be a hydrofoiling watercraft.

Thus, the watercraft 10 may comprise one or more hydrofoil arrangements 200. The one or more hydrofoil arrangements 200 may be connected to the hull module 20. The one or more hydrofoil arrangements 200 may be configured to be arranged below the underside of the hull module 20.

Preferably, the one or more driveline modules 30 may be adapted to be mounted to the one or more hydrofoil arrangements 200. Hence, each driveline module 30 may be adapted to be mounted to a hydrofoil arrangement 200. In one example, a plurality of driveline modules 30 may be mounted to one hydrofoil arrangement 200. In one example, not more than a single driveline module 30 may be mounted to a hydrofoil arrangement 200. A hydrofoil arrangement 200 intended to have one or more driveline modules mounted thereon may herein be considered a propulsion hydrofoil arrangement.

In one example, one or more driveline modules 30 may be fixedly mounted to a hydrofoil arrangement 200. According to such an example, the hydrofoil arrangement may be considered forming a part of the driveline module 30. Hence, in one example, the driveline module 30 may comprise a hydrofoil arrangement 200.

The hydrofoil arrangement 200 may comprise a mast 202. The mast 202 may be adapted to connect a hydrofoil portion of the hydrofoil arrangement 200 to the hull body 20. As will be described, the hydrofoil arrangement 200 may comprise one or a plurality of masts 202. In one example, the hydrofoil arrangement 200 may be devoid of a mast 202, whereby the hydrofoil portion may be directly connected to the hull module 20.

The hydrofoil portion of the at least one hydrofoil arrangement may comprise at least one hydrofoil wing.

Referencing FIG. 1a, a first hydrofoil arrangement 200 may comprise two masts 202. The two masts 202 may connect to the hydrofoil portion of the hydrofoil arrangement 200. A first and second driveline module 30 may be mounted to the hydrofoil arrangement 200. The first driveline module 30 may be mounted to the first mast 202 and the second driveline module 202 may be mounted to the second mast 202. The hydrofoiling portion of the hydrofoil arrangement 200 may comprise a hydrofoil wing 201. The hydrofoil wing may be connected to the first and second mast 202 via the first and second driveline module 30. Thus, the hydrofoil wing 201 may be mounted to the first and second driveline module 30.

The hydrofoil wing 201 may be mounted to the driveline module 30 by means of any conventional fastening means such as one or more fastening elements or a snap-fit connection. Advantageously, the hydrofoil wing 201 may be releasably mounted to the driveline module 30.

Further referencing FIG. 1a, the watercraft 10 may comprise a second hydrofoil arrangement 200. The hydrofoil arrangement 200 may comprise a mast 202 connecting the hull module 20 and the hydrofoil wing 203. The hydrofoil arrangement 200 may be a hydrofoil arrangement 200 devoid of a driveline module, thus the second hydrofoil arrangement may herein be considered a support hydrofoil arrangement.

FIG. 1b depicts the watercraft of FIG. 1a with a driver or user being seated in a driving position.

The watercraft 10 may comprise a seating portion 210. The seating portion 210 may be intended to accommodate a seated driver of the watercraft 10.

The seating portion 210 may have an upper seating surface. The upper seating surface may be adapted to provide seated support for the driver while operating the watercraft 10.

It may be envisioned that the seating portion 210 may be adapted to accommodate one or more passengers in addition to the driver.

In the depicted example, the seating portion 210 is in the form of a saddle extending along the longitudinal center axis C of the hull module 20. The saddle may be adapted to accommodate for one or more passengers seated directly behind the driver of the watercraft 10.

In an alternative example, the seating portion 210 may be in the form of one or multiple seats.

The seating portion 210 may be connected to the hull module 20 via a support structure 600. The support structure 600 may be adapted to provide a distance between the upper seating surface of the seating portion 210 and the hull module 20. The support structure 600 may be adapted to provide a vertical distance, i.e. a vertical distance between the seating portion 210 and the hull module 20 and/or the upper seating surface and the hull module 20.

The seating portion 210 may be arranged above an upper surface of the hull module 20. The support structure 600 may be adapted to provide a vertical distance between the upper seating surface and the upper surface of the hull module 20. In one example, the seating portion 210 may be mounted to said upper surface of the hull module 20 by means of the support structure 600.

FIG. 1c depicts an alternative embodiment of the watercraft 10 according to the example of FIG. 1a. As shown in FIG. 1c, the watercraft 10 may comprise a single electric power module 50. The single electric power module 20 may be received in a compartment 24. The single electric power module 20 may be configured to be connected to the first and second driveline module 30 to form the driveline system.

FIG. 1d depicts the driveline module 30 in further detail.

The one or more driveline module 30 may comprise at least one motor 32 in driving connection with at least one propelling member via a drive shaft. The motor may 32 be comprised in a motor unit which also may comprise power electronics.

In one example, the driveline module 30 may comprise a first and second motor configured to drive a first and second propelling member, respectively. The second motor may be configured to drive the second propelling member in a direction opposite to the direction which the first motor is configured to drive the first propelling member.

The propelling member may for example be in the form of a jet drive or a jet drive. In one example, at least one of the driveline modules 30 may comprise a jet drive 31 for propelling the watercraft 10. Thus, the driveline module may comprise an impeller, a stator, a nozzle arranged in this successive order to form the jet drive. Optionally, jet drive may comprise inlet guide vanes arranged upstream the impeller. The motor 32 may thus be configured to drive the impeller. The jet drive may be a jet drive unit.

In one example, at least one of the driveline modules 30 may comprise a propeller drive for propelling the vehicle. The driveline module 30 may accordingly comprise at least one motor in driving connection with at least one propeller for propelling the watercraft. Each motor may be connected to the at least one propeller via a drive shaft. The propeller drive may be a propeller drive unit.

Advantageously, the motor 32 may be arranged to be at least partially submerged in the water during operation of the watercraft 10 in the water such that the motor 32 is provided with passive cooling from the water. In one embodiment, the one or more driveline modules 30 may be arranged such that substantially the entire motor 32 of each of said driveline module 30 is arranged beneath the water surface during operation of the watercraft 10 during operation of the watercraft 10 in the water.

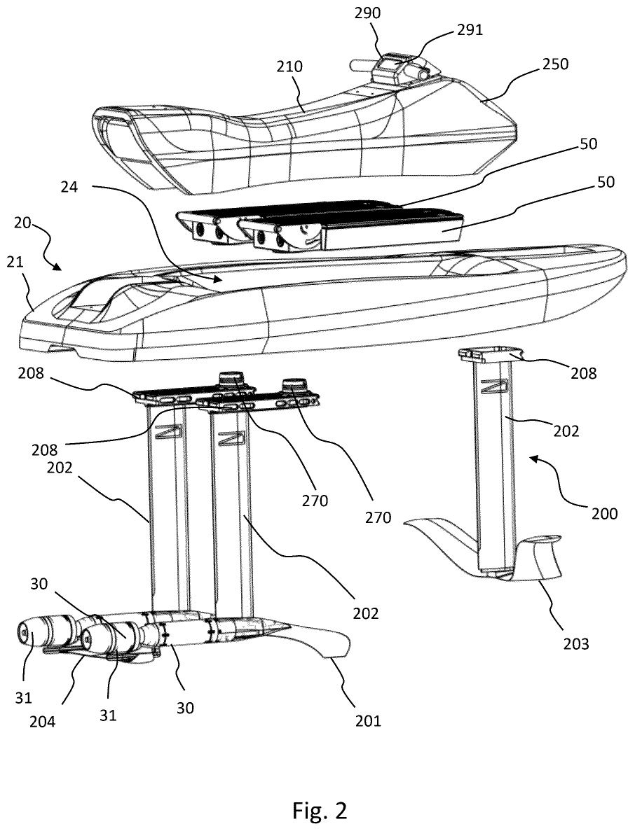

FIG. 2 depicts an explosion view of the watercraft 10 according to one example.

In one example, the one or more driveline modules 30 may be adapted to be mounted directly to the hull module 20.

In order to further allow for adaptability of the watercraft 10, the one or more driveline modules 30 may comprise a connection interface. The connection interface may be adapted to be mountable both directly to the hull module 20 and the one or more hydrofoil arrangements 200. Thus, the hydrofoil arrangement(s) 200 and the hull module 20 may be provided with corresponding connection interfaces for mounting of the driveline module 30.

In one example, the one or more driveline modules 30 may be electrically connected to the one or more electric power modules 50. In one example, the one or more driveline modules 30 may be mechanically and electrically connected to the electric power modules.

As depicted in FIG. 2, the one or more electric power modules 50 and the one or more driveline modules 30 may be connected via a connection arrangement. The connection arrangement may comprise a driveline module connector 270. The driveline module connector 270 may be electrically connected to the driveline module 30. The connection arrangement may further comprise an electric power module connector electrically connected to the electric power module 50. The electrical power module connector and the driveline module connector 270 may be connectable to form a mechanical and electrical connection between the driveline module 30 and the electric power module 50. The electrical power module connector and the driveline module connector 270 may be releasably connectable.

It may be envisioned that any suitable number of electric power modules may be connected to any suitable number of driveline modules via one connection arrangement. Thus, one electric power module may be connected to multiple driveline modules, one driveline module may be connected to multiple electric power modules or a single electric power module may be connected to a single driveline module.

In one example, the electrical power module connector and the driveline module connector 270 may form a blind-mate connection. The electrical power module connector may and the driveline module connector may form a waterproof connection such as a waterproof blind-mate connection.

In one example, the connection arrangement may further enable data communication between the driveline module 30 and the electric power module 50.

In one example, the driveline module connector 270 may be provided on the driveline module 30. In one example, the driveline module connector 270 may be provided on the hydrofoil arrangement 200. According to such an embodiment, a wired electrical connection may be provided through the hydrofoil arrangement from the driveline module 30 to the driveline module connector 270.

The watercraft 10 may comprise an operations module 250. The operations module 250 may be adapted to be detachably mounted to the hull module 20. The operations module may comprise the seating portion 210.

In one example, the support structure 600 may be adapted to connect the hull module 20 and the operations module 250. The support structure 600 may be adapted to provide a distance between the operations module 250 and the hull module 20.

The support structure 600 may be adapted to connect the operations module 250 and the hull module 20. The support structure 600 may be releasably connected to the operations module 250 and/or the hull module 20.

At least one of the one or more hydrofoil arrangements 200 may be detachably connected to the hull module 20 thereby forming a hydrofoil module. The hydrofoil module may be adapted to be detachably connected to the hull module 20. Preferably each hydrofoil arrangement 200 is adapted to be detachably connected to the hull module 20.

The hydrofoil arrangement(s) 200 may be provided with hull connecting portions 208. In one example, the one or more mast 202 may be provided with a hull connecting portion 208 for connecting the mast 202 to the hull module 20.

In one example, if one or more driveline module 30 is mounted to the hydrofoil arrangement, the hull connection portion 208 of the hydrofoil arrangement 200 may be provided with the driveline module connector 270. In one example, one driveline module connector 270 may be provided on the hydrofoil arrangement for each driveline module 30 mounted to the hydrofoil arrangement 200. In one example, one driveline module connector 270 may be connected to a plurality of driveline modules 30 mounted to the hydrofoil arrangement 200.

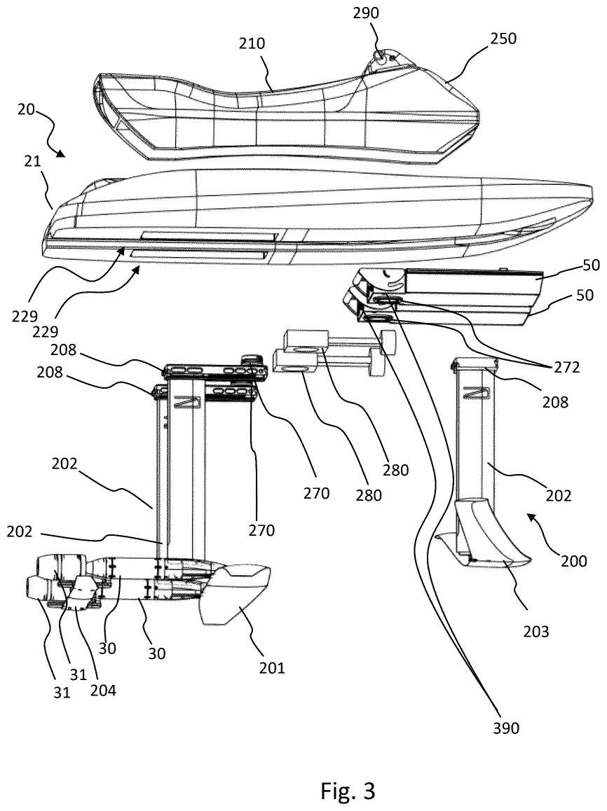

With reference to FIG. 3, an explosion view of the watercraft 10 according to one example is depicted.

The watercraft 10 may comprise one or more electric power module connectors 272. The one or more electric power module connectors 272 may be provided on the one or more electric power modules 50. In the depicted example, a first electric power module is provided with a first electric power module connector 272 and a second electric power module is provided with a second electric power module connector 272.

The first electric power module connector 272 may be connectable to a first driveline module connector 270. The second electric power module connector 272 may be connectable to a second driveline module connector 270.

In the depicted example, the watercraft 10 comprises a connection module 280. At least one electrical power module 50 and at least one driveline module 30 may be connectable via the connection module 280.

In one example, the driveline module connector(s) 270 and the electrical power module connector(s) 272 may be connectable via the connection module 280. Referencing FIG. 3, the first and second driveline module connector 270 may be connectable to the connection module 280. The first and second electric power module connector 272 may be connectable to the connection module 280.

The connection module 280 may be formed as a single unit or as a plurality of units. In the depicted example, a first electric power module connector 272 and a first driveline module connector 270 are connectable to a first connection unit of the connection module 280. Correspondingly, a second electric power module connector 272 and a second driveline module connector 270 are connectable to a second connection unit of the connection module 280.

The connection module 280 may comprise electrical and mechanical connections allowing for direct connection to one or more electrical power module 50 and one or more driveline module 30. In one example, the connection module 280 may comprise a communication interface for data communication between the one or more electrical power module and the one or more driveline module. The communication interface may be in the form of a Central Area Network (CAN) interface.

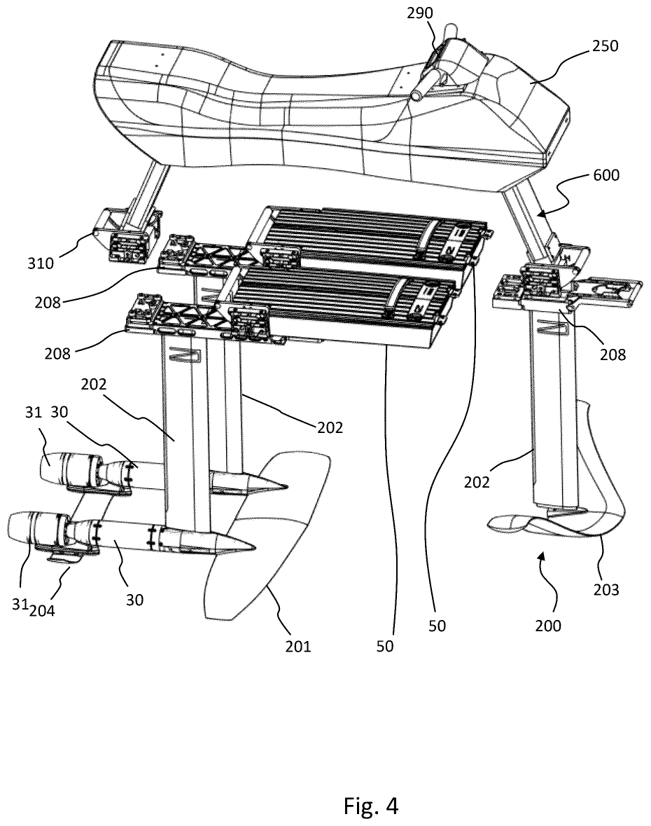

Turning to FIG. 4, an explosion view of another example of the watercraft 10 is depicted. In the depicted example, one or more of the electric power modules 50 may be connected to the one or more driveline module 30 without the connection module.

Thus, the driveline module connector 270 may be directly connectable to the electric power module connector 272.

The driveline module connector 270 may extend into the hull module 20. Preferably, the driveline module connector 270 may extend into the hull module 20. The driveline module connector 270 may extend into a through hole of the hull module 20. The through hole may enable access to the compartment 24 for the electric power module. Thus, the driveline module connector 270 may extend into the compartment 24 and thereby enable mechanical and electrical connection between the electric power module 50 and the driveline module 30. This may be achieved by means of connecting the driveline module connector 270 with the electric power module connector 272.

Further referencing FIG. 4, the support structure 600 may be releasably connected to the hull module 20 and/or the seating portion 210. The watercraft 10 may comprise a releasable support structure locking arrangement 310 adapted to retain the support structure 600 to the hull module 20 and/or the seating portion 210.

In one example, the support structure 600 may be releasably connected to the hull module 20 and/or the operations module 250. The watercraft 10 may comprise a releasable support structure locking arrangement 310 adapted to retain the support structure 600 to the hull module 20 and/or the operations module 250.

In one example, the releasable support structure locking arrangement 310 may comprise a movable locking element provided on the support structure 600 or the hull module 20 and adapted to engage a corresponding locking member provided on the other of the support structure 600 or the hull module 20 to thereby retain the support structure to the hull module 20.

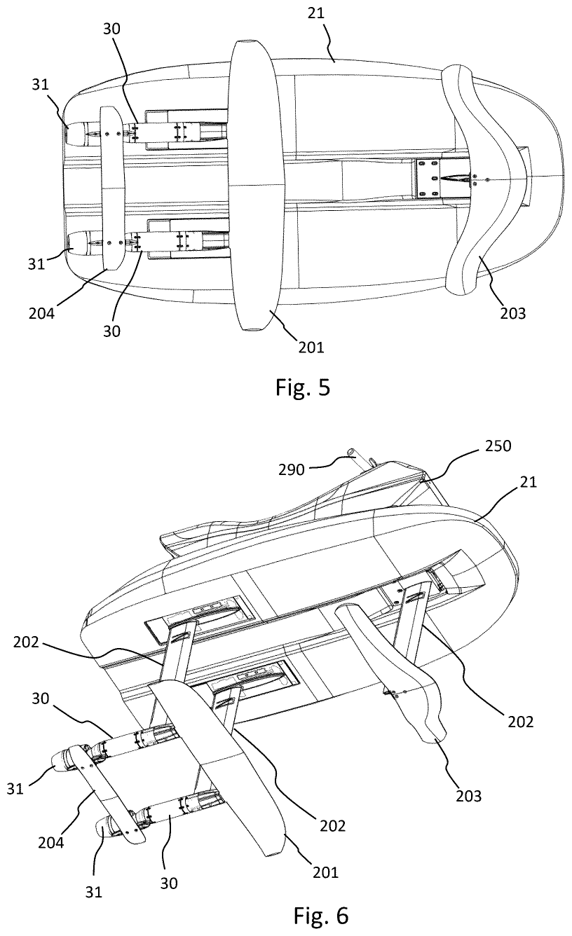

As will be described with reference to FIG. 5-8, the one or more driveline module 30 and the one or more electrical power module may be electrically and mechanically connectable via the one or more through holes of the hull module 20.

Referencing FIG. 5-6, the hydrofoil arrangements 200 may be releasably connected to the underside of the hull module 20. The hull connecting portions of the hydrofoil arrangements 200 may be adapted to be received by mounting compartments provided in the underside of the hull module 20. The mounting compartments are most clearly shown in FIG. 3.

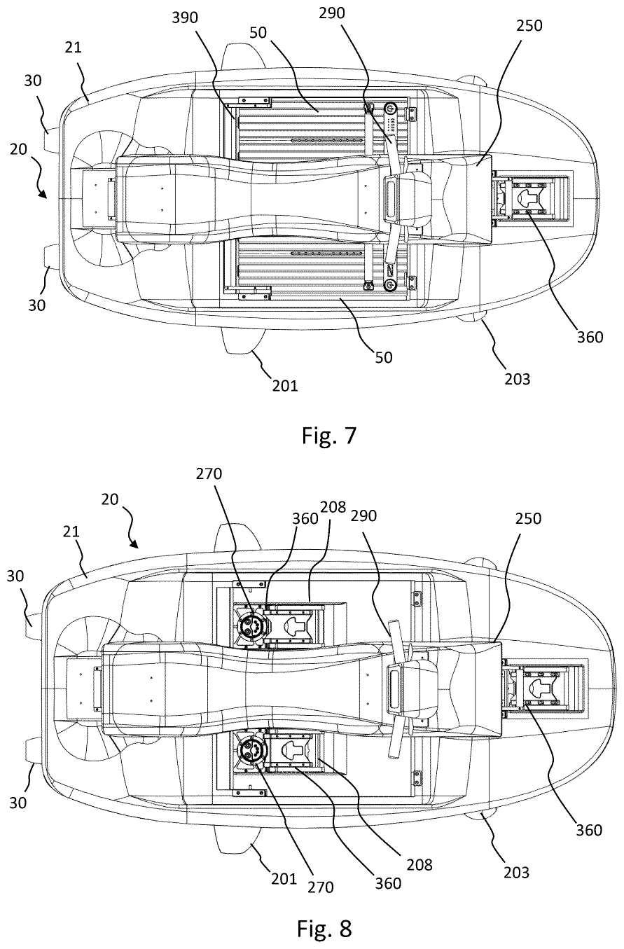

Referencing FIG. 7, a top view of a watercraft 10 according to one example is depicted.

As depicted, the watercraft 10 may comprise locking arrangement for releasably locking the modules in their mounted position.

The watercraft 10 may comprise an electric power module locking arrangement 390 adapted to releasably retain the electric power module 50 to the hull module 20. The electric power module locking arrangement 390 may comprise a movable locking element provided on the electric power module 50 or the hull module 20 adapted to engage a locking member provided on the other of the electric power module 50 and the hull module 20 to thereby retain the electric power module 50 to the hull 20 and preferably retain the electric power module 50 in the compartment 24.

FIG. 8 depicts the watercraft 10 of FIG. 7 with the electric power modules removed.

As depicted in FIG. 8, each hydrofoil arrangement may be releasably retained to the hull module by means of a hydrofoil locking arrangement 360.

Thus, the watercraft 10 may comprise a hydrofoil locking arrangement 360 adapted to releasably retain the hydrofoil arrangement to the hull module 20. The hydrofoil locking arrangement 360 may comprise a movable locking element provided on the hydrofoil arrangement 200, preferably the hull connecting portion 208 of the hydrofoil arrangement, or the hull module 20 adapted to engage a locking member provided on the other of the hydrofoil arrangement 200 and the hull module 20 to thereby retain the hydrofoil arrangement 200 to the hull module 20.

In the depicted example, the watercraft 10 comprises three hydrofoil locking arrangement, one for each mast intended to be mounted to the hull module 20.

The hull connecting portions 208 of the hydrofoil arrangement may be provided with the driveline module connector 270. The hull connecting portions 208 may be releasably retained to the hull module by means of the hydrofoil locking arrangement 360.

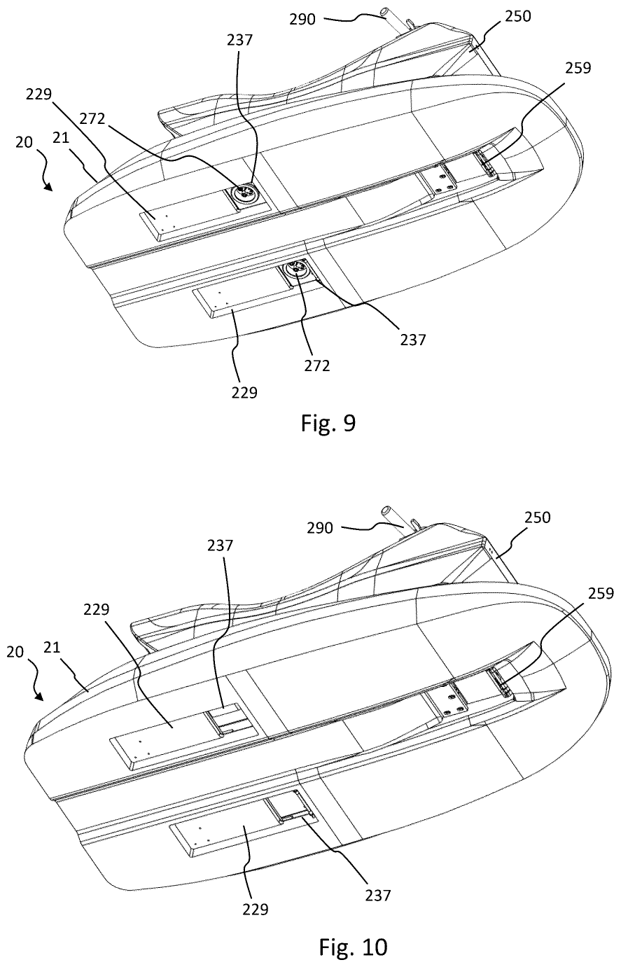

FIG. 9-10 depicts the watercraft 10 of FIG. 7 from below with and without electric power modules, respectively. The underside of the hull module 20 may be provided with one or more mounting compartments 229 providing access for the driveline module connector 270 to the electric power module 50. The one or more mounting compartments 229 may be adapted to receive and hold a portion of the hydrofoil arrangement 200. Thus, the mounting compartments 229 may in one example be adapted to hold and receive the hull connecting portions of a hydrofoil arrangement.

As depicted, the hull module comprises the one or more through holes 237. The through holes 237 may extend through the hull module 20 and enable the driveline module connector 270 to connect to the electric power module connector 272.

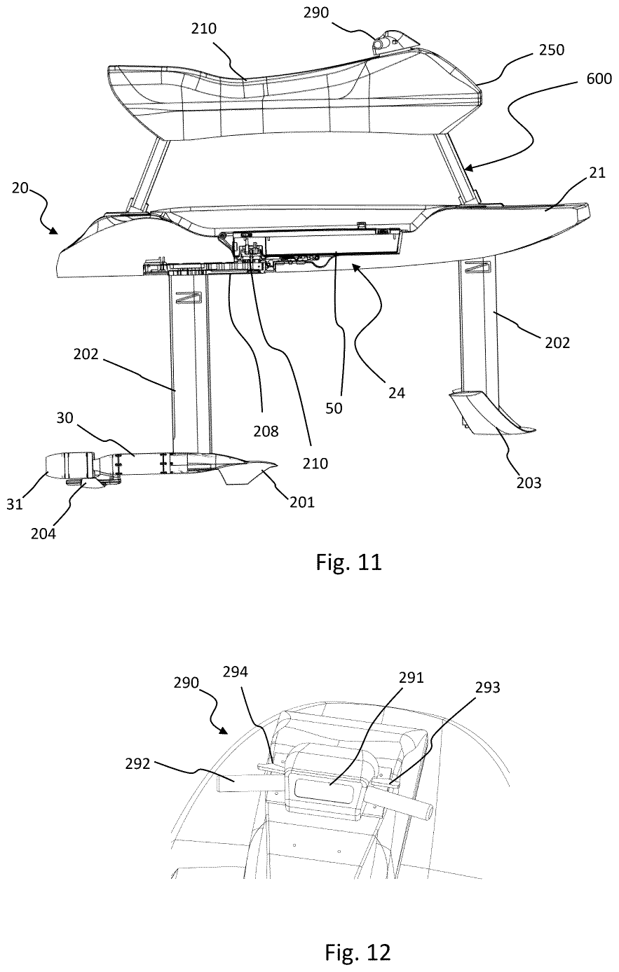

FIG. 11 depicts the watercraft 10 in a partial cross-section view.

The electric power module 50 is received in the compartment 24. The electric power module 50 may be electrically and mechanically connected to the driveline module 30 via the hull connecting portion 208 of the hydrofoil arrangement 200. The driveline module 30 may be connected to electric power module 50 the via the connection arrangement. In one example, the connection arrangement may comprise the electric power module connector 272 and the driveline module connector 270. The electric power module 50 may be arranged vertically above the driveline module connector 270. Hence, a bottom surface of the electric power module 50 may at least partially abut to an upper surface of the hull connecting portion 208.

FIG. 12 depicts aspects of an exemplary steering system of a watercraft.

The watercraft may comprise one or more controlling units 293, 294 configured to cause control of the speed of the one or more driveline modules 30 based on user input data obtained from a user interface of the one or more controlling units 293, 294. The interface of the controlling units 293, 294 may comprise a throttle. The throttle may be in the form of a trigger.

The user interface of the one or more controlling units 293, 294 may be configured to acquire a variable speed signal from the user interface. The variable speed signal may be associated with a corresponding speed of the driveline modules. Hence, the control system of the watercraft may be configured to set the speed of the driveline module based on the obtained variable speed signal from the user interface.

The one or more controlling units 293, 294 may be arranged on the operations module 250. The steering system may comprise the one or more controlling units 293, 294.

Advantageously, the steering system may be provided in a steering module. The steering module may be mounted to the operations module 250 or the hull module 20. Preferably, the steering module is mounted to the operations module 250. Thus, the steering module may be arranged on the operations module 250. In one example, the steering module is releasably connected to the operations module 250.

As depicted in FIG. 12, the watercraft 10 may comprise a display device 291. The display device 291 may be operatively connected to the control system of the watercraft 10. The display device 291 may be configured to display parameter data such as vehicle speed, battery state of charge etc.

In the examples of FIG. 1-11, multiple driveline modules are utilized. Thus it is enabled to provide steering by means of individual speed control of the driveline modules 30. Steering may herein refer to causing the watercraft 10 to change course.

Preferably, at least one first driveline module 30 is arranged on the first side of the longitudinal center axis C and at least one second driveline module 30 is arranged on the second side of the longitudinal center axis C. The watercraft may thus be configured to be steerable my means of individual speed control of the at least one first driveline module and the at least one second driveline module. Thus, the watercraft 10 may be configured to be steerable by means of the speed of the first driveline module(s) being controlled independently of the speed of the second driveline module(s). The watercraft 10 may thus be steerable to turn based on the difference in speed between the at least one first driveline module and the at least one second driveline module.

The at least one first driveline module 30 may be considered at least one right driveline module arranged on the right side of the longitudinal center axis C. The at least one second driveline module 30 may be considered at least one left driveline arrangement arranged on the left side of the longitudinal center axis C. Thus, the at least one first driveline module 30 may be considered at least one starboard driveline module arranged on the starboard side of the watercraft. The at least one second driveline module 30 may be considered at least one port driveline arrangement arranged on the port side of the longitudinal center axis C.

This is particularly advantageous in combination with the watercraft 10 also being steerable by means of the body weight of a user. Hence, the watercraft 10 may be steerable by means of individual speed control of the driveline modules 30 and the shifting of the body weight of a user. According to such an example, the watercraft is advantageously steered by means of the individual control of the speed of the driveline modules at low speeds wherein steering by means of shifting of body weight is difficult and challenging. Steering by means of shifting of body weight is easier and more efficient at higher speeds. Hence, at higher speeds the user may instead utilize his/her body to maneuver and steer the vehicle.

The watercraft 10 may comprise a first controlling unit 293 and a second controlling unit 294. The first controlling unit 293 may be configured to cause control of the at least one first driveline module 30 based on user input data obtained from the user interface of said first controlling unit 293. The second controlling unit 294 may be configured to cause control of the speed of the at least one second driveline module 30 based on user input data obtained from the user interface of the second controlling unit 294.

The controlling of the speed of the driveline module may comprise controlling any component of the driveline module affecting the propelling speed of the watercraft. The controlling of the speed of the driveline module may comprise at least one of controlling the speed of the at least one motor 31 of the driveline module, controlling the speed of the shaft connecting the motor and controlling a variable geometry of a nozzle, rotor or impeller.

In one example, the controlling of the speed of the driveline module may comprise controlling the motor speed of the at least one motor 31 of the driveline module.

To achieve a more intuitive manner of steering, the watercraft 10 may comprise a steering element 292. The one or more controlling unit 293, 294 and the steering element 292 may be configured to cause individual control of the speed of the at least one first driveline module 30 and the at least one second driveline module 30 based on the user input data obtained from the user interface of the at least one controlling unit 293, 294 and the position of the steering element 292.

The steering system may thus comprise the steering element 292. The steering element 292 may be provided with a position sensor operatively connected to the control system of the watercraft for acquiring the position of the steering element 292.

In one example, the steering element 292 may be detachable, e.g. detachable from the watercraft 10. The driveline system may be operable without the steering element 292. The steering element 292 may be detachably mounted to the operations module 250.

In one example, the steering element 292 may be in the form of a handle bar. The steering element 292 may be rotatable. In one example, the one or more controlling units 293, 294 may be mounted to the steering element 292.

In one example, the steering system 290 may be mounted to the operations module 250. In one example, the steering system 290 may be mounted to the seating portion 210.

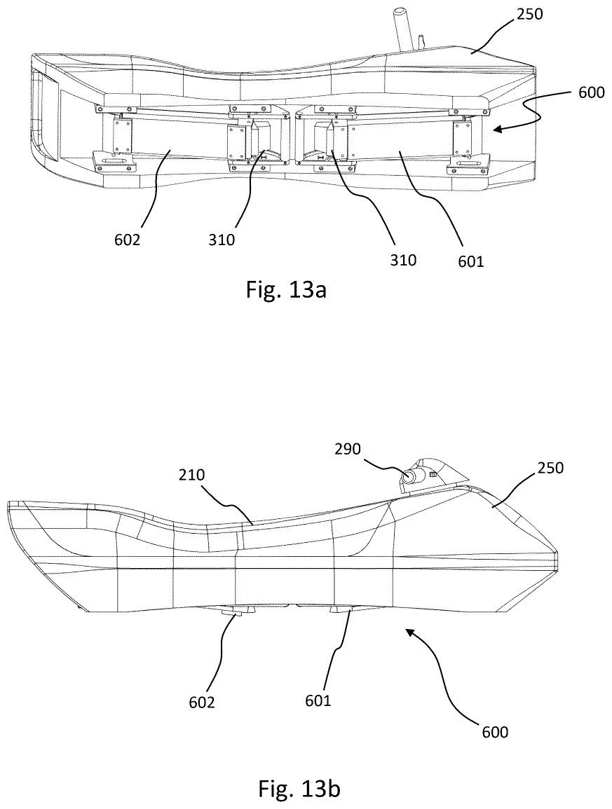

FIG. 13a-b, depicts the seating portion 210 and operations module 250 in further detail. The support structure 600 may comprise one or more legs 601, 602 connecting the hull module 20 and the seating portion 210 and/or the operations module 250 and the hull module 20. In the depicted example, the support structure 600 comprises a first leg 601 and a second leg 602. The first leg 601 may be a front leg and the second leg 602 may be a rear leg.

In one example, the support structure 600 may be adjustable between a first position and a second position. In the first position, the seating portion 210 is elevated relative the hull module 20. In the second position, the seating position 210 is lowered relative the hull module 20.

In other words, in the first position, the seating portion 210 may be elevated relative the hull module 20 in relation to an intermediate position. In the second position, the seating portion 210 may be lowered relative the hull module 20 in relation to the intermediate position. The intermediate position may be an intermediate position of the support structure between the first and second position.

The support structure 600 may be adjustable in a vertical direction. Thus, the support structure 600 may be adapted to raise and lower the seating portion 210 and/or the operations module 260.

Further referencing FIG. 13a-b, the support structure 600 may be foldable. The first and second leg 601, 602 may thus be pivotally connected to the seating portion 210 and/or the operations module 250 and the hull portion 210 such that the vertical position of the seating portion 210 and/or the operations module 250 relative the hull module 20 may be adjusted.

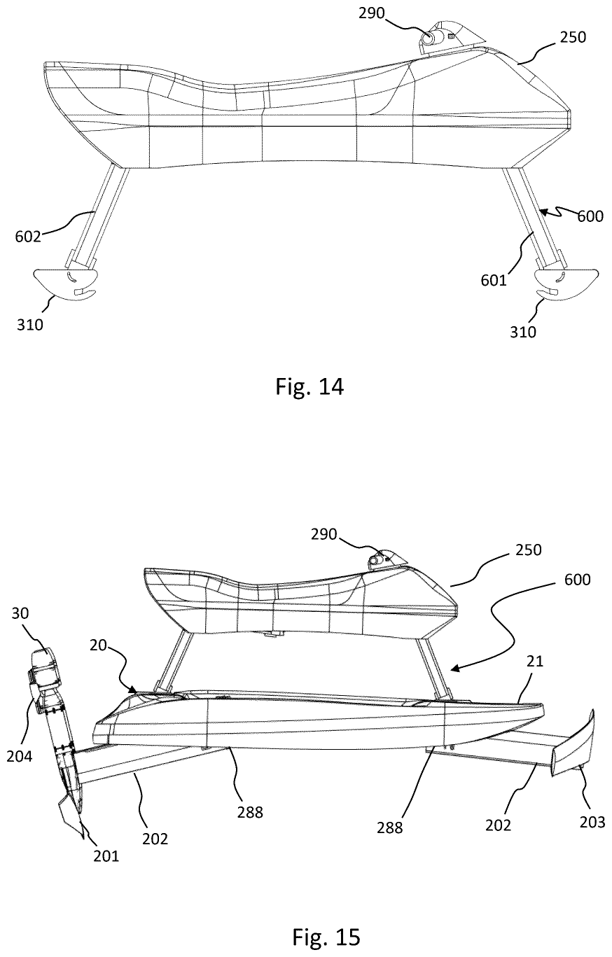

As depicted in FIG. 14, the first leg 601 and the second leg 602 may each be provided with a movable locking element of a releasable support structure locking arrangement 310. Each movable locking element may be adapted to engage a corresponding locking member provided on the hull module 20 to thereby retain the support structure, e.g. the first and second leg, to the hull module 20.

FIG. 15 depicts a side view of a watercraft 10 according to one example. At least one of the one or more masts 202 may be connected to the hull module 20 by means of a pivot connection 288. The pivot connection may enable moving of the one or more mast 202 between a deployed position and a stowed away position. In the stowed away position, the mast 202 may extend at least partially along the hull module 20. In the deployed position, the mast 202 may extend downwards from the underside of the hull module. In one example, the watercraft 10 may comprise pivot retaining means adapted to retain the mast 202 in the deployed and/or stowed away position.

The pivot connection may be provided in addition to or as an alternative to the releasable connection between the hydrofoil arrangement(s) 200 and the hull module 20.

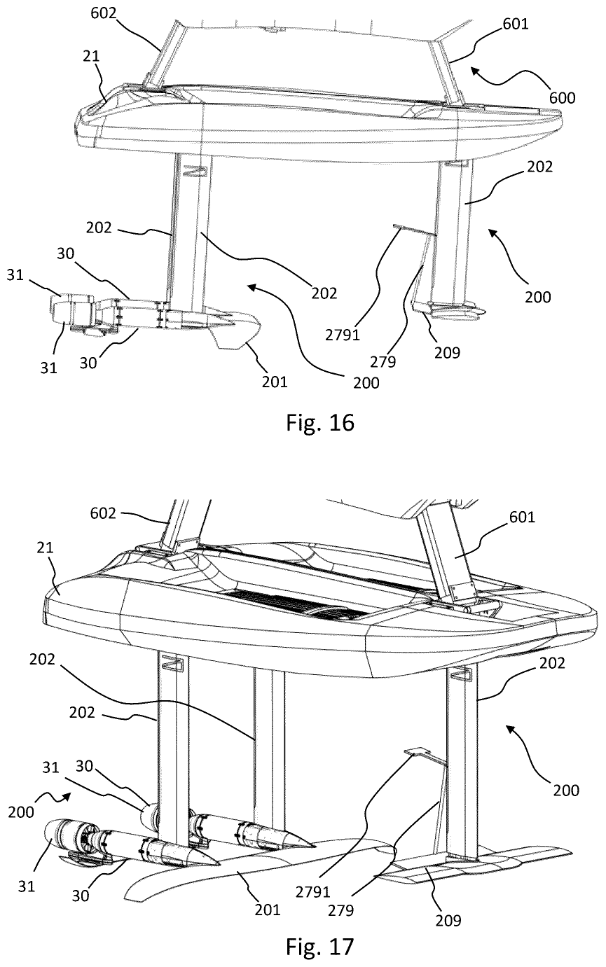

FIGS. 16 and 17 depicts hydrofoil arrangements 200 according to one example in further detail.

In one example, at least one of the hydrofoil arrangements 200 may comprise a movable wing 209. The movable wing 209 may be connected to a regulating member 279 for controlling the position of the movable wing 209.

In one example, the movable wing 209 may pivotable relative a horizontal axis.

The regulating member 279 may be mechanically or electrically operated. In one example, the regulating member 279 may be in the form of an actuator causing actuation of the movable wing between the hydrofoiling position and the non-hydrofoiling position.

In the depicted example, the regulating member 279 is mechanically operable. The regulating member may comprise an actuating flap 2791. The regulating member 279 may thus be movable as a result of the actuating flap 2791 interacting with the water during operation.

Upon the actuating flap 2791 being in line with the water surface, the water engaging flap 2791 may be substantially horizontally arranged thereby causing the regulating member 279 to urge the regulating member 279 to be in a substantially horizontal position.

Upon the actuating flap 2791 being under water, the water pressure will cause the actuating flap 2791 to tilt upwards, thereby causing the movable wing 209 to be tilted upwards relative a horizontal position. Thus, the movable wing 209 may be positioned to guide the watercraft 10 diagonally upwards towards a hydrofoiling state.

Upon the water engaging flap being above water, the actuating flap 209 will not be subjected to the pressure of the water, whereby the regulating member 279 may cause the movable wing 209 to be in a resting position. In the resting position, the movable wing may be tilted downwards relative a horizontal position.

In one example the movable wing 209 may be stand-alone wing. In one example, the movable wing 209 may be in the form of a flap mounted to another wing of the hydrofoil arrangement 200.

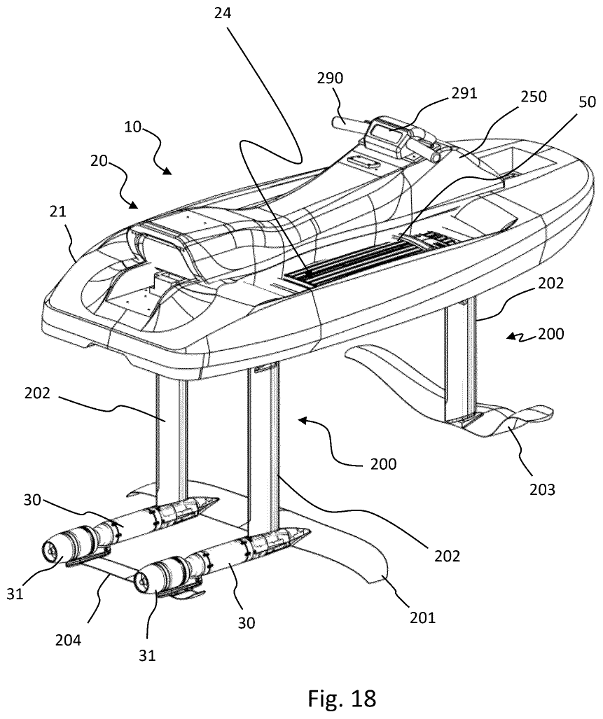

FIG. 18 depicts a perspective view of the watercraft 10 according to one example. In this example, the seating portion 210 is directly mounted to the hull module 20. The seating portion 210 may be integrated into the hull module 20. Alternatively, the operations module 250 may be directly connected to and preferably directly releasably connected to the hull module 20.

Hence, the seating portion 210 and the operations module 250 may be mounted directly to the hull module 20 without the support structure.

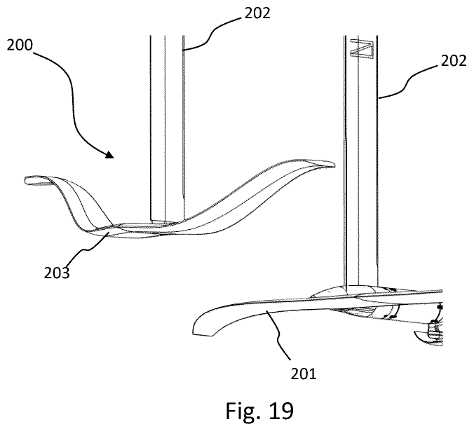

FIG. 19 depicts the hydrofoil arrangements 200 according to one example in further detail.

As depicted, a front hydrofoil arrangement may comprise a wing 203 with upwardly extending wing tips designed to provide stability and turning capability. As also depicted, a rear hydrofoil arrangement may comprise a wing 201 with downwardly extending wing tips designed to provide stability and turning capability.

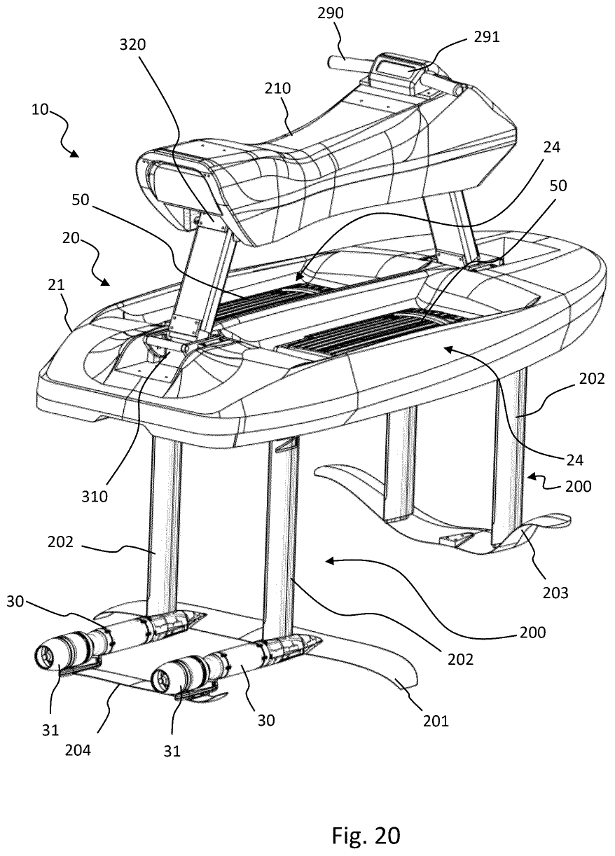

FIG. 20 depicts the watercraft 10 according to another example. In the depicted example, one of the hydrofoil arrangements 200, e.g. the front hydrofoil arrangement, may comprise two masts 202 connecting the hydrofoil portion to the hull module 20 in order to increase the stability of the watercraft 10.

As depicted, the rear hydrofoil arrangement may be a propulsion hydrofoil arrangement and the front hydrofoil arrangement may be a support hydrofoil arrangement. The front hydrofoil arrangement may be arranged at a front portion of the hull module 20 and the rear hydrofoil arrangement may be arranged at a rear portion of the hull module 20.

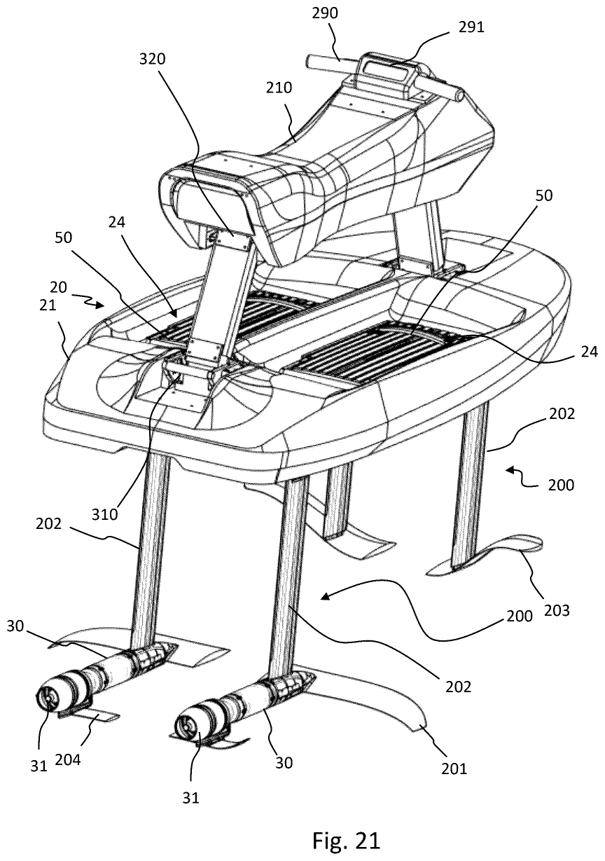

FIG. 21 depicts the watercraft 10 according to yet another example. In the depicted example, the watercraft 10 comprises four hydrofoil arrangements 200. The watercraft 10 may comprise two front hydrofoil arrangements 200 and two rear hydrofoil arrangements 200. The front hydrofoil arrangements 200 may be support hydrofoil arrangements and the rear hydrofoil arrangements 200 may be propulsion hydrofoil arrangements. Each of the hydrofoil arrangements may comprise a mast 202 and a hydrofoil portion comprising a wing 201, 203.

A driveline module 30 may be mounted to each of the rear hydrofoil arrangements 200. The first rear hydrofoil arrangement may be mounted on the first side of the longitudinal center axis C and the second rear hydrofoil arrangement may be mounted on the second side of the longitudinal center axis C.

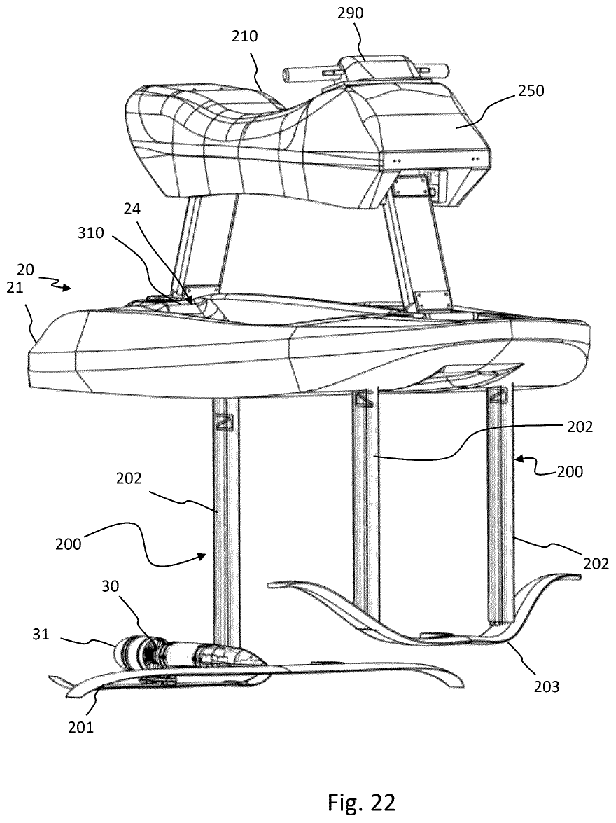

Turning to FIG. 22, another example of the watercraft 10 is depicted. The watercraft 10 may comprise one driveline module 30. The driveline module 10 may be mounted to a hydrofoil arrangement 200. The driveline module 10 may be mounted to a rear hydrofoil arrangement 200. The rear hydrofoil arrangement 200 may thus be a propulsion hydrofoil arrangement. The rear hydrofoil arrangement 200 may be arranged at a position disposed at the longitudinal center axis C of the hull module 20.

The watercraft 10 may comprise a front hydrofoil arrangement 200. The front hydrofoil arrangement 200 may be a support hydrofoil arrangement. The front hydrofoil arrangement may comprise two masts 202 connecting the hydrofoiling portion to the hull module 20.

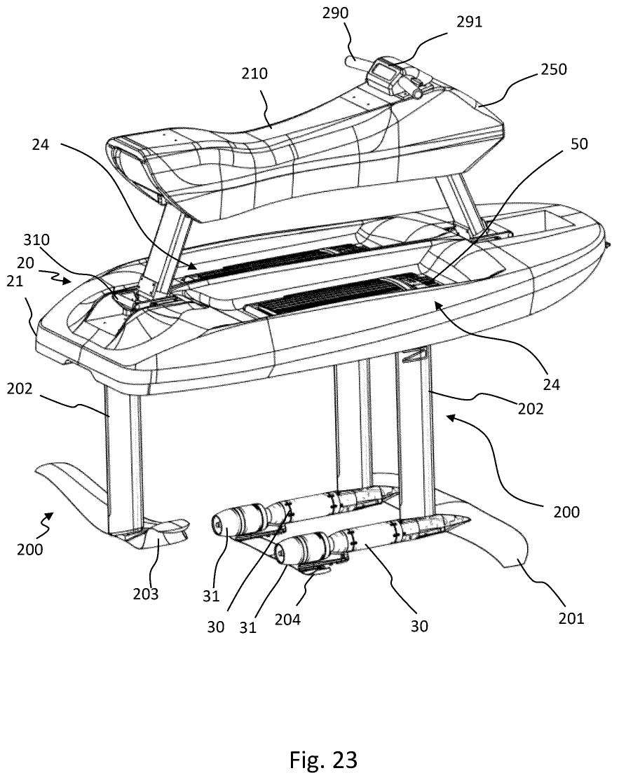

FIG. 23 depicts the watercraft 10 according to yet another example. In the depicted example, the watercraft 10 comprises a rear hydrofoil arrangement. The rear hydrofoil arrangement 200 may be a support hydrofoil arrangement.

The watercraft 10 may comprise a front hydrofoil arrangement. The front hydrofoil arrangement 200 may be a propulsion hydrofoil arrangement. Two driveline modules 30 may be mounted to the front hydrofoil arrangement 200. A wing 201 may be mounted to said two driveline modules 30. The front hydrofoil arrangement 200 may comprise two masts 202. A first driveline module 30 may be mounted to the first mast 202 and a second driveline module 30 may be mounted to the second mast 202.

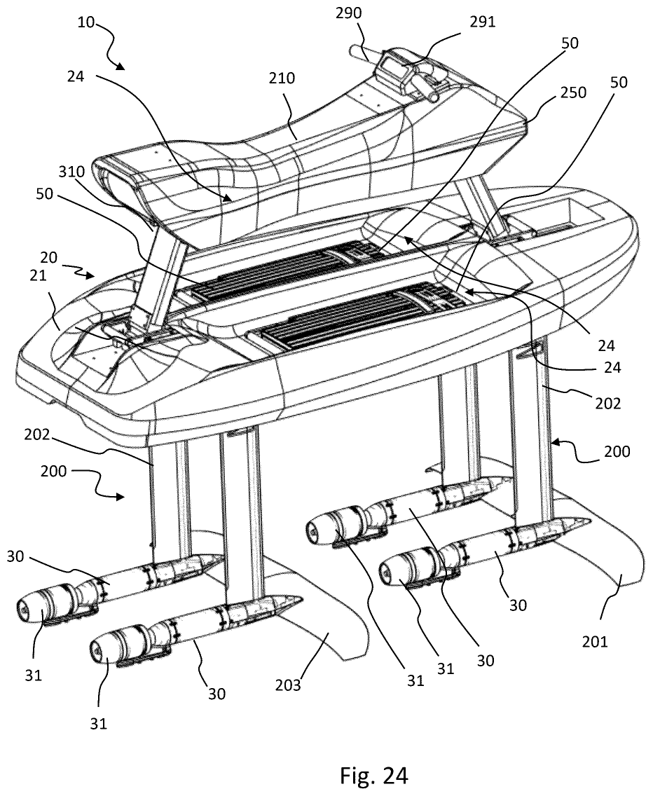

FIG. 24 depicts the watercraft 10 according one example. In the depicted example, the watercraft 10 comprises a rear and a front hydrofoil arrangement 200. The front and rear hydrofoil arrangement 200 may be propulsion hydrofoil arrangements.

Thus, two driveline modules 30 may be mounted to the front hydrofoil arrangement. A first driveline module 30 may be mounted to a first mast 202 of the front hydrofoil arrangement 200. A second driveline module 30 may be mounted to a second mast 202 of the front hydrofoil arrangement 200.

Two driveline modules may be mounted to rear hydrofoil arrangement. A first driveline module 30 may be mounted to a first mast 202 of the rear hydrofoil arrangement. A second driveline module 30 may be mounted to a second mast 202 of the rear hydrofoil arrangement.

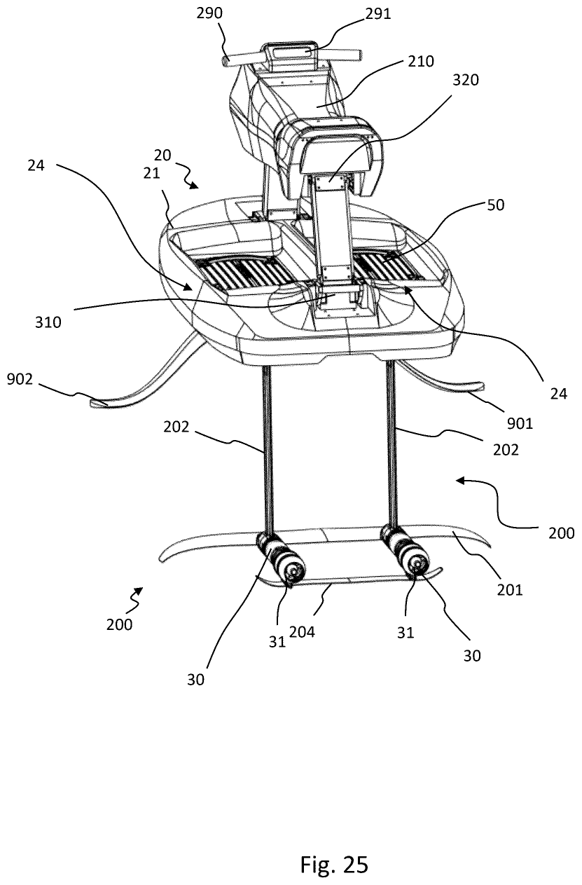

FIG. 25 depicts the watercraft 10 according to another example. The watercraft 10 may comprise one or more stabilizing wing 901, 902. The one or more stabilizing wing 901, 902 may be mounted to the hull module 20. The one or more stabilizing wing 901, 902 may be arranged to extend at an angle downwardly from the hull module 20. In the depicted example, the watercraft 10 comprises a first stabilizing wing 901 extending downwardly and outwardly from the hull module 20. The watercraft 10 further comprises a second stabilizing wing 902 being arranged opposite to the first stabilizing wing 901 and extending downwardly and outwardly from the hull module 20.

Further referencing FIG. 25, the watercraft 10 may comprise one hydrofoil arrangement 200. The hydrofoil arrangement 200 may be a propulsion hydrofoil arrangement. A first and second driveline module 30 may be mounted to the hydrofoil arrangement 200. The hydrofoil portion may comprise a front wing 201 and a rear wing 204. The front wing 201 may be mounted to a front portion of the driveline modules 30. The rear wing 204 to a rear portion of the driveline modules 30.

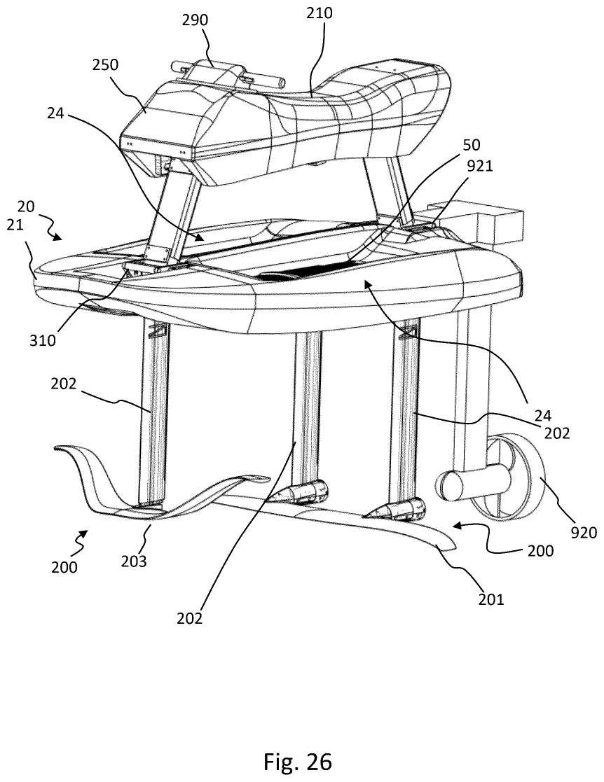

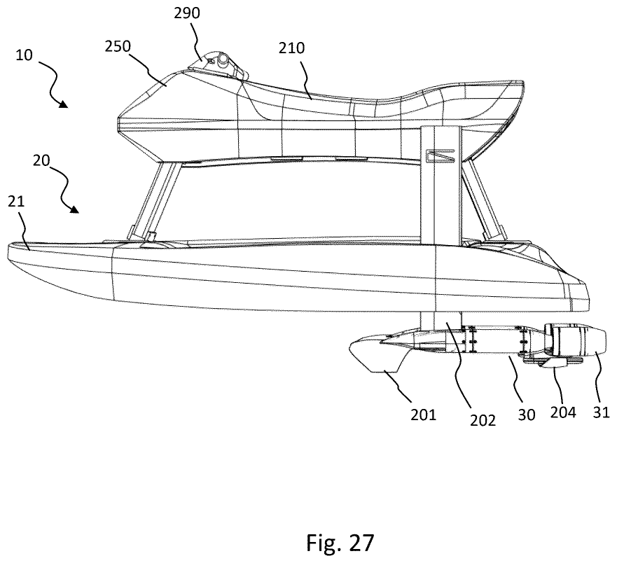

As depicted in FIG. 26, the watercraft 10 may comprise means for mounting an outboard propulsion unit. The watercraft 10 may comprise an outboard connection arrangement 921. The outboard connection arrangement 921 may be adapted to provide a releasable mounting for one or more outboard propeller motor system or outboard jet motor system 920 for propelling the watercraft 10. In one example, the hull module 20 may comprise the outboard connection arrangement.

Referencing FIG. 27, one or more of the masts 202 of the hydrofoil arrangement 200 may be adjustably connected to the hull module 20 such that the distance, e.g. the vertical distance, between the hydrofoil portion of hydrofoil arrangement 200 and the hull module 20 is adjustable. Thereby, the hydrofoiling properties of the watercraft 10 may be adapted based on user preference, intended travelling speed etc.

The one or more masts 202 may be adjustably connected to the hull module 20 by means of any type of suitable adjustable connection available to the skilled person. The one or more masts 202 may be adjustably connected to the hull module 20 by means of an adjustable connection adapted to enable displacement of the one or more masts 202 in a direction substantially perpendicular to the longitudinal center axis C of the hull module 20. In one example, the adjustable connection may comprise a gearing interface between the one or more masts 202 and the hull module 20. The gearing interface may for example comprise a pinion and gear rack.

The adjustable connection may be manually operable, electrically and/or electromagnetically operable. In one example, the adjustable connection may be hand-operated by a user in order to set the displacement of the one or more masts 202 relative the hull module. In one example, the watercraft may comprise one or more adjustment actuators adapted to cause the displacement of the one or more mast 202. The adjustment actuator may for example be a servo motor or an electrical motor.

In one example, each of one or more hydrofoiling arrangements 200 of the watercraft 10 may be adjustable by means of the one or more masts being adjustably connected to the hull module 20. In one example, only selected hydrofoil arrangements 200 of a plurality of hydrofoil arrangements 200 of the watercraft 10 may be adjustable by means of the one or more masts being adjustably connected to the hull module 20.

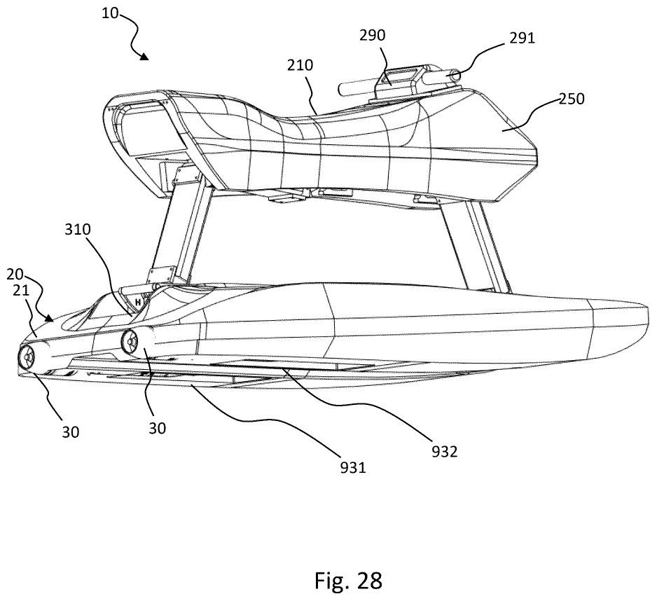

FIG. 28 depicts another example of the watercraft 10. According to the depicted example, the one or more driveline modules 30 may be configured to be connected to an underside of the hull module 20 by means of being arranged in one or more compartment 931, 932 provided in the underside of the hull module 20. Hence, each driveline module 30 may be adapted to be arranged in a driveline module compartment 931, 932 provided as a recess in the underside of the hull module 20. According to such an example, the watercraft 10 may be provided without any hydrofoil arrangements, thus the driveline module(s) may be mounted directly to the hull module 20.

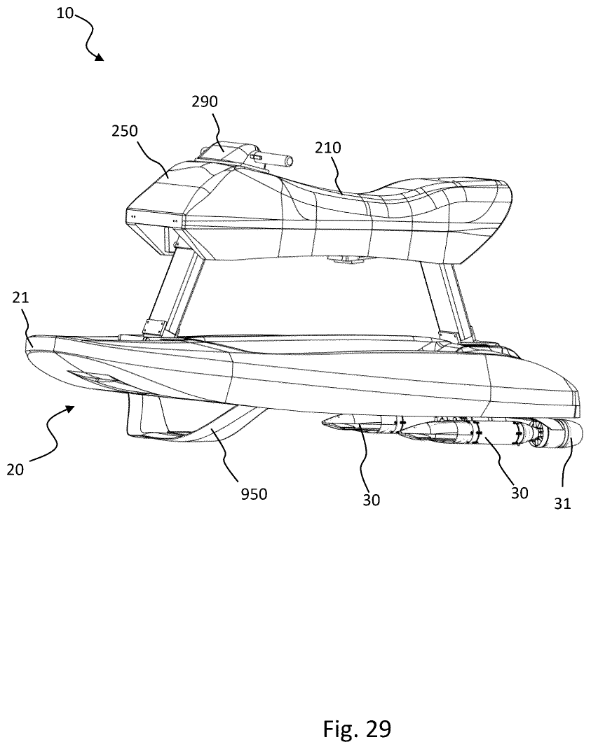

Another example of the watercraft 10 is depicted in FIG. 29. The watercraft 10 may comprise a hydrofoil arrangement 200. The hydrofoil arrangement 200 may be a front hydrofoil arrangement 200. The hydrofoil arrangement 200 may be a support hydrofoil arrangement. The hydrofoil arrangement 200 may comprise a hydrofoil wing 950 directly mounted to the hull module 20.

The watercraft 10 may comprise one or driveline modules 30 mounted to a rear portion of the hull module 20. The one or more driveline modules 30 may be arranged at the rear portion of the hull module 20. The one or more driveline modules 30 may be directly mounted to the hull module 20. In the depicted example, the watercraft 10 comprises a first driveline module mounted on a first side of the longitudinal center axis C of the hull module 20 and a second driveline module mounted on a second side of the longitudinal center axis C.

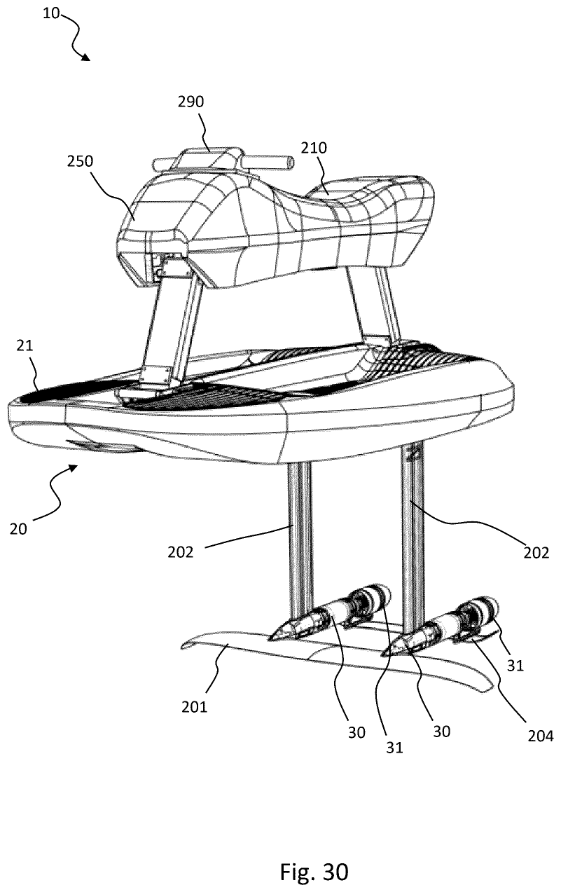

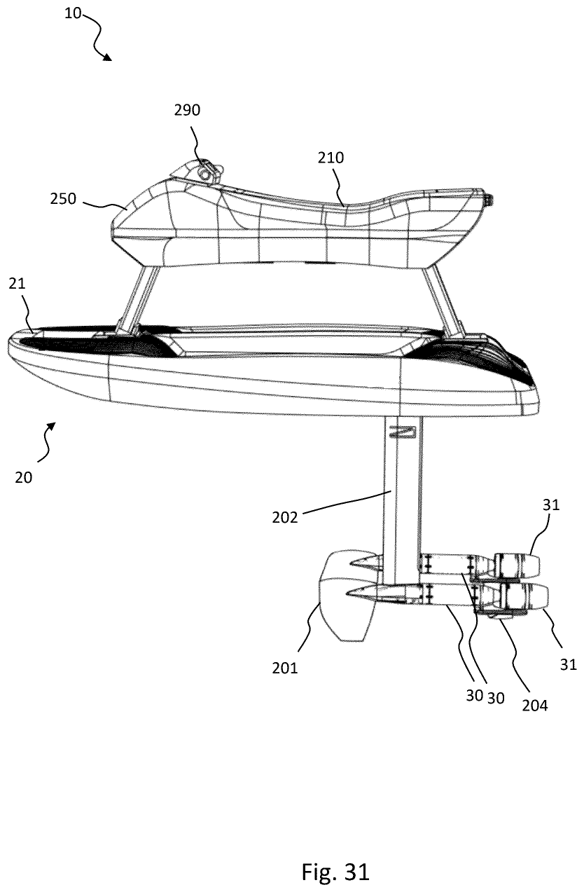

FIG. 30-31 depict one example of the watercraft 10. The watercraft 10 comprises one hydrofoil arrangement 200. The hydrofoil arrangement 200 may be mounted to a rear portion of the hull module 20. The hydrofoil arrangement 200 may be a rear hydrofoil arrangement.

The hydrofoil arrangement 200 may be a propulsion hydrofoil arrangement. A first driveline module 30 and a second driveline module 30 may be mounted to the hydrofoil arrangement 200.

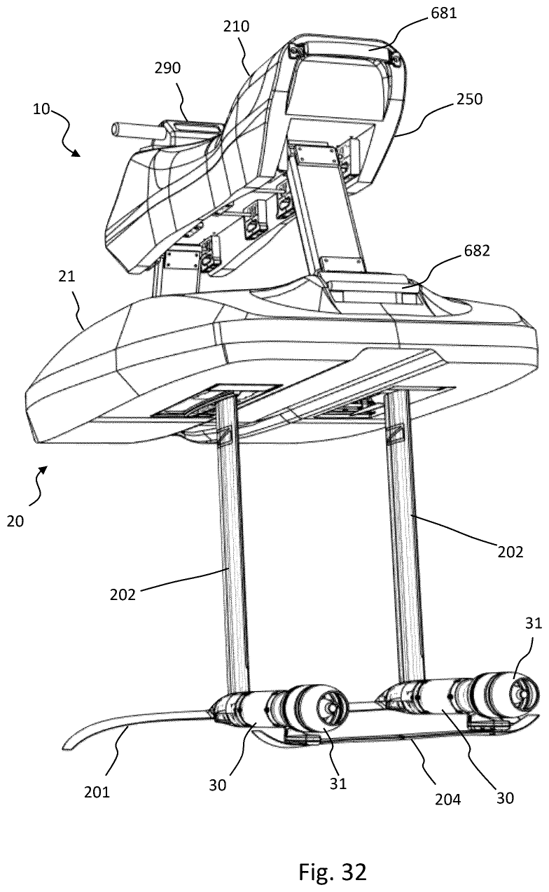

As depicted in FIG. 32, the watercraft 10 may comprise a handle 681, 682 for accessing the watercraft from the water. Hence, the handle 681, 682 may be arranged to provide a user assistance in climbing onto the watercraft 10 from the water.

Preferably, the handle 681, 682 may be arranged at a rear portion of the watercraft 10, it may however be envisioned that the handle is mounted to a front portion of the watercraft 10. In one example, the watercraft 10 may comprise more than one handle 681, 682. In the depicted example, the watercraft 10 comprises a first handle 681 and a second handle 682.

In one example, the handle 681 may be mounted to the seating portion 210. In one example, the handle 681 may be mounted to the operations module 250.

In one example, the handle 682 may be mounted to the hull module 20. In one example, the handle 682 may be mounted to a rear portion 682 of the hull module 20.

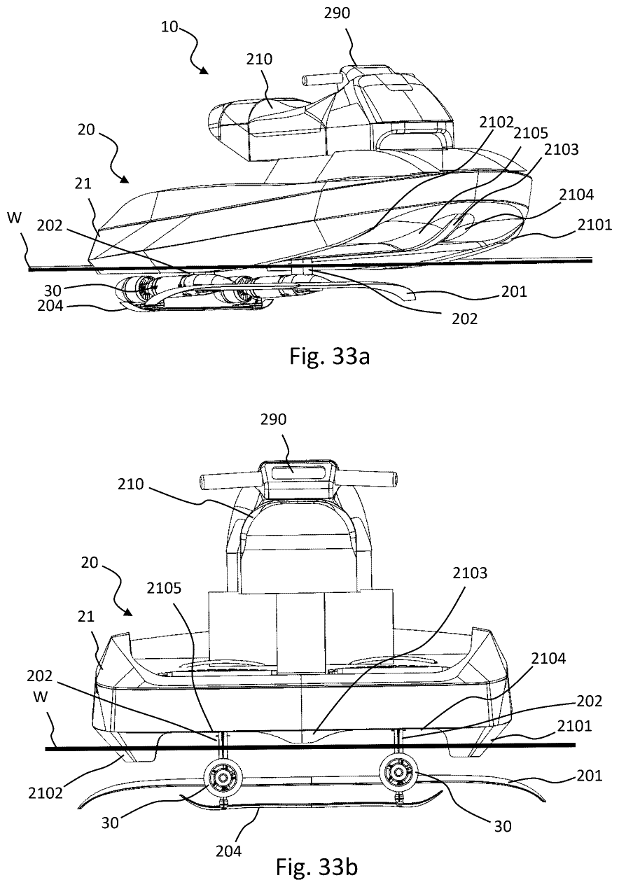

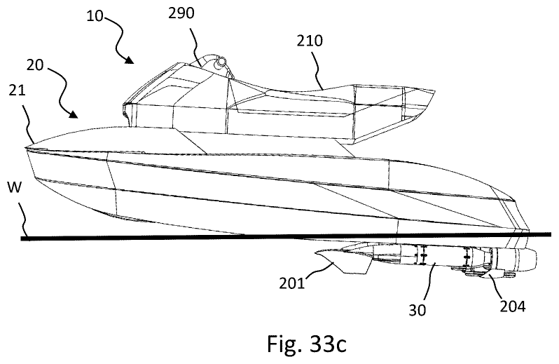

The watercraft 10 according to one example is depicted in FIGS. 33a-c. FIG. 33a-c depicts the watercraft 10 according to one example when operated in the water. The water surface is denoted the water surface W in said figures.

According to the examples herein, the watercraft 10 may comprise one or more hydrofoil arrangements 200. Depending on the properties of the one or more hydrofoil arrangements 200, the lifting force provided by the one or more hydrofoil arrangements during the operation of the watercraft 10 may differ. Accordingly, the extent to which the hull module 20 is raised relative to the water surface W may be based on the speed of the watercraft 10 and the properties of the one or more hydrofoil arrangements 200.

At lower speeds of the watercraft 10, i.e. at lower travelling speeds of the watercraft 10, the watercraft 10 may operate in a normal operational state. In the normal operational state, the hull module 20 may be at least partially submerged in the water. The lifting force keeping the watercraft 10 at a relatively constant vertical level relative to the water surface will essentially be generated by the buoyancy of the hull module 20. In the normal operational state, a relatively large portion of the outer surface of the hull module 20 may be in contact with the water. Notably, said portion may comprise both vertically and horizontally extending surfaces of the hull module 20. In some examples, the entire underside of the hull module 20 may be in contact with the water in the normal operational state.

The large portion of the outer surface of the hull module 20 being in contact with the water causes the resistance for the movement of the watercraft 10 in the water to be relatively high, thereby negatively impacting the speed as well as the energy efficiency of the watercraft 10.

The one or more hydrofoil arrangements 200 may address these issues. As the speed of the watercraft 10 increases, the one or more hydrofoil arrangements 200 may generate a lifting force. The lifting force may cause raising of the watercraft 10 and the hull module 20 relative to the water surface W. Depending on the properties of the one or more hydrofoil arrangements 200, the hull module 20 may be raised relative to the water surface such that the hull module 20 is lifted above the water surface entirely or such that a smaller portion of the outer surface of the hull module 20 is in contact with the water compared to the normal operational state.

A state wherein the lifting force generated by the one or more hydrofoil arrangements 200 causes a smaller portion of the outer surface of the hull module 20 to be in contact with the water compared to the normal operational state may be considered a semi-foiling state. Hence, in a semi-foiling state, the hull module 20 may still be in contact with the water. In the semi-foiling state, the one or more hydrofoil arrangements 200 provides a supporting surface for the watercraft 10 while the hull module 20 still is in contact with and/or supported by the water surface W.

A state wherein the lifting force generated by the one or more hydrofoil arrangements 200 causes the hull module 20 to not be in contact with the water may be considered a fully hydrofoiling state. In the fully hydrofoiling state, the one or more hydrofoil arrangements 200 provides a supporting surface of the watercraft 10 while the hull module 20 is not in contact with and/or not supported by the water surface W.

In a fully hydrofoiling state, the resistance against the movement of the watercraft 10 in the water is low, positively impacting the top speed as well as the energy-efficiency of the watercraft 10. In the case of the one or more hydrofoil arrangements 200 being configured to enable the fully hydrofoiling state, said one or more hydrofoil arrangements 200 may be configured to cause the watercraft 10 to enter the fully hydrofoiling state from the normal operational state as the speed of the watercraft 10 increases during operation in the water. As aforementioned, the hull module 20 is not in contact with the water in the fully hydrofoiling state.

As previously described, at least one of the one or more hydrofoil arrangements 200 may comprise one or more masts 202 connecting a hydrofoil portion of the hydrofoil arrangement 200 to the hull body 20. The one or more masts 202 may be adapted to enable the fully hydrofoiling state.

The height of the masts 202 and/or the dimension of the hydrofoil portion, e. g. the at least one wing of the hydrofoil portion may be adapted to enable the fully hydrofoiling state. Relative to wings and masts adapted to enable only a semi-hydrofoiling state, the masts may be higher and/or the wings may be wider and/or larger and may be positioned at a greater distance from the underside of the hull module 20.

Although the resistance against the movement of the watercraft 10 in the water will be somewhat higher for a semi-hydrofoiling state compared to a fully hydrofoiling state, the semi-hydrofoiling state is associated with a number of advantages.

FIGS. 33a-c depicts an example of a watercraft 10 operable in a semi-hydrofoiling state. The semi-hydrofoiling state enables a faster and more energy-efficient watercraft. Furthermore, compared to a fully hydrofoiling state, the semi-hydrofoiling state may be achieved without complex and costly stabilizing means in the form of speed or stability control systems or mechanical stabilization means. In addition, the semi-hydrofoiling state may be achieved with smaller and less space-consuming hydrofoil arrangements making the watercraft more compact. Also, typically, a semi-hydrofoiling state may be achieved at lower speeds of the watercraft compared to a fully-hydrofoiling state, making the watercraft 10 more efficient at lower travelling speeds.

Referencing the example of FIGS. 33a-c, the one or more hydrofoil arrangements 200 may be configured to cause the watercraft 10 to enter the semi-hydrofoiling state during operation in water from the normal operational state as the speed of the watercraft 10 increases. In the semi-hydrofoiling state, the portion of the outer surface of the hull module 20 being in contact with the water surface W (depicted in FIG. 33a-b) is smaller compared to the portion of said outer surface of the hull module 20 being contact with the water surface W in the normal operational state.

As previously described, at least one of the one or more hydrofoil arrangements 200 may comprise one or more masts 202 connecting a hydrofoil portion of the hydrofoil arrangement 200 to the hull body 20. The one or more masts 202 may be adapted to enable the semi-hydrofoiling state. It may however also be envisioned that the hydrofoil portion of the hydrofoil arrangement 200, e.g. the one or more wings of the hydrofoil portion, is directly mounted to the elongated hull 20. Hence, the hydrofoil arrangement may not comprise the one or more masts 202.

The height of the masts 202 and/or the dimension of the hydrofoil portion, e.g. the at least one wing 201, 204 of the hydrofoil portion may be adapted to enable the semi-hydrofoiling state. Relative to wings and masts adapted to enable a fully hydrofoiling state, the masts 202 may be shorter and/or the wings 201, 204 may be narrower and/or smaller and may be positioned at a shorter distance from the underside of the hull module 20. As shown in the example of FIGS. 33a-c, the masts 202 may be relatively short allowing for the hydrofoil wings 201, 204 to be positioned relatively close to the underside of the hull module 20.

The one or more hydrofoil arrangements 200 may be configured such that the watercraft 10 is maintained in the semi-hydrofoiling state when the one or more driveline modules 30 operates at full speed. Accordingly, the one or more hydrofoil arrangements 200 may be configured to maintain the watercraft 10 in the semi-hydrofoiling state when the watercraft 10 is operated at a travelling speed corresponding to the maximum operating speed of the one or more driveline modules 30. Thus, even when the watercraft 10 reaches its maximum travelling speed, the semi-hydrofoiling state may be maintained.

As the watercraft 10 transitions from the normal operational state to the semi-hydrofoiling state, the front of the hull module 20 may be elevated relative to the water surface W. Thereby, the portion of the outer surface of the hull module 20 being in contact with the water is reduced. The one or more hydrofoil arrangement 200 may thus be configured to cause the front of the hull module 20 to elevate relative to the water surface W as the watercraft 10 transitions from the normal operational state to the semi-hydrofoiling state.

To accentuate this effect and as depicted in FIG. 33a-c, the one or more hydrofoil arrangements 200 may be arranged closer to a rear end of the watercraft 10 than a front end of the watercraft 10. In one example, the hydrofoil portion of the one or more hydrofoiling arrangement 200 may be arranged closer to a rear end of the watercraft 10 than a front end of the watercraft 10. In one example, the one or more wings 201, 204 may be arranged closer to the rear end of the watercraft 10 than a front end of the watercraft 10.

The semi-hydrofoiling state is obtainable with a hull module 20 with a flat underside, but it may be particularly advantageous when the hull module 20 is of a hull type with pontoons 2101, 2102, 2103, for example for hull modules forming a catamaran hull or trimaran hull. As the skilled person is well-aware, pontoons are downwardly protruding hull potions which extends longitudinally and are adapted to engage the water surface.

The pontoon configuration of the hull module 20 reduces the surface area in contact with the water, further reducing the resistance and improving the energy efficiency of the watercraft 10. Furthermore, in the semi-foiling state, air is allowed to flow underneath the underside of the hull module 20 between the pontoons 2101, 2102, 2103 further enabling the raising of the hull module 20 relative to the water surface W. In one example, the pontoons 2101, 2102, 2103 may be configured such that the pontoons are the only part of the hull module 20 in contact with the water in the semi-foiling state. In one example, only the rear portion of the pontoons 2101, 2102, 2103 may be in contact with the water in the semi-foiling state further allowing for the reduced resistance against the movement of the watercraft 10 in the water.

In one example, the hull module 20, e.g. the flotation body 21 of the hull module 20, may comprise two or more pontoons 2101, 2102, 2103 for engaging the water. The two or more pontoons 2101, 2102, 2103 may be considered and/or formed as downwardly protruding elongated protrusions. The elongated protrusions may face downwardly. The elongated protrusions may extend along the hull module 20.

Said pontoons 2101, 2102, 2103 may extend longitudinally. The pontoons 2101, 2102, 2103 may extend at least partially parallel to the longitudinal center axis C of the hull module 20. In one example, the two or more pontoons 2101, 2102, 2103 may extend along the entire hull module 20. In one example, the two or more pontoons 2101, 2102, 2103 may extend along only a portion of the hull module 20. In one example, the two or more pontoons 2101, 2102, 2103 may extend from a rear end of the watercraft 10.

In one example, a first pontoon 210 may be arranged on a first side of the longitudinal center axis C and at a horizontal distance from said longitudinal center axis C and a second pontoon 2102 may be arranged on a second side of the longitudinal center axis C and at a horizontal distance from said longitudinal center axis C. The first side may be opposite to said second side. In one example, the first pontoon 2101 of the two or more pontoons may form a first outer bottom longitudinal edge of the hull module 20 and the second pontoon 2102 of the two or more pontoons may form a second outer bottom longitudinal edge of the hull module 20. The second outer bottom longitudinal edge may be opposite to the first outer bottom longitudinal edge.

The two or more pontoons 2101, 2102, 2103 may improve the maneuverability of the watercraft 10 due to pontoons improving the grip of the hull module 20 in the water during turning maneuvers. This may particularly be the case in for a watercraft 10 being steerable by means of the body weight of a user, as it enables the user to easier cause the watercraft 10 to turn by means of shifting the body weight.

In one example, the pontoons 2101, 2102, 2103 may be formed by one or more elongated channels 2104, 2105 provided on the underside of the hull module 20. Hence, each pair of pontoons and/or protrusions may be separated by an elongated channel 2104, 2105. The one or more channels 2104, 2105 may be formed by elongated depressions in the underside of the hull module 20. In one example, the one or more channels 2104, 2105 may be configured to enable air flow through said channels along the hull module 20. In particular the channels 2104, 2105 may be configured to enable air flow through said channels along the hull module 20 in the fully hydrofoiling state, the semi-foiling state and/or the normal operational state. In one example, the channels 2104, 2105 may be configured to enable flow through said channels when the watercraft 10 is travelling in a straight and forward direction.

In the example depicted in FIG. 33a-c, the hull module 20 forms a trimaran hull. Accordingly, the hull module 20 comprises three pontoons 2101, 2102, 2103 and/or elongated protrusions. The three pontoons 2101, 2102, 2103 may extend parallel to each other. The three pontoons 2101, 2102, 2103 may be separate by means of channels 2104, 2105. The three pontoons may comprise a first pontoon 2101, a second pontoon 2102 and a third pontoon 2103. The third pontoon 2103 may be arranged between the first 2101 and the second pontoon 2102. The first pontoon 2101 and the third pontoon 2103 may be separated by a first channel 2104 and the second pontoon 2102 and the third pontoon 2103 may be separated by a second channel 2104. The third pontoon 2103 may be aligned with the center axis C of the hull module 20. The first pontoon 2101 and the second pontoon 2102 may be arranged on opposite sides of said center axis C.

In one example, the one or more driveline modules 30 may comprise at least one first driveline module 30 arranged on a first side of the longitudinal center axis C and at least one second driveline module 30 arranged on a second side of the longitudinal center axis C. The watercraft 10 may be configured to be steerable by means of individual speed control of the driveline modules 30. The steering provided by means of the individual speed control may be improved by the improved turning maneuverability provided by the pontoons.

The steering provided by means of the individual speed control may also be improved in examples where the hydrofoil arrangement 200 is configured to cause the watercraft 10 to operate in the semi-foiling state. This is due to the relatively elevated position of the driveline modules 30 when the watercraft 10 is in the semi-foiling state. As the watercraft 10 will begin to tilt about the longitudinal center axis C of the hull module 20, one of the first and second driveline module 30 will be lowered and the other raised. Due to the driveline modules 30 elevated position in the semi-foiling state, the raised driveline module 30 may even be raised up above the water surface W, thereby the driveline module 30 does not provide any resistance or counteracting propulsion force to the watercraft 10 during the turning maneuver thus making the turn easier to perform. This effect is further amplified by the potential use of a hull module 20 with pontoons.

In the depicted examples, the first driveline module is aligned with the first channel 2104 and the second driveline module is aligned with the second channel 2105.

Although the example depicted in FIGS. 33a-c comprises a single hydrofoil arrangement 200 with two wings 201, 204 and two driveline modules 30, it may be envisioned that any of the type of hydrofoil arrangements 200 and configurations of hydrofoil arrangements described herein may be utilized in order to achieve a semi-foiling state. For example, it may be envisioned that a single driveline module 30 may be mounted to the hydrofoil arrangement 200 or that the watercraft may comprise a plurality of hydrofoil arrangements 200, whereby a driveline module 30 may be mounted to at least one of said hydrofoil arrangements 200.

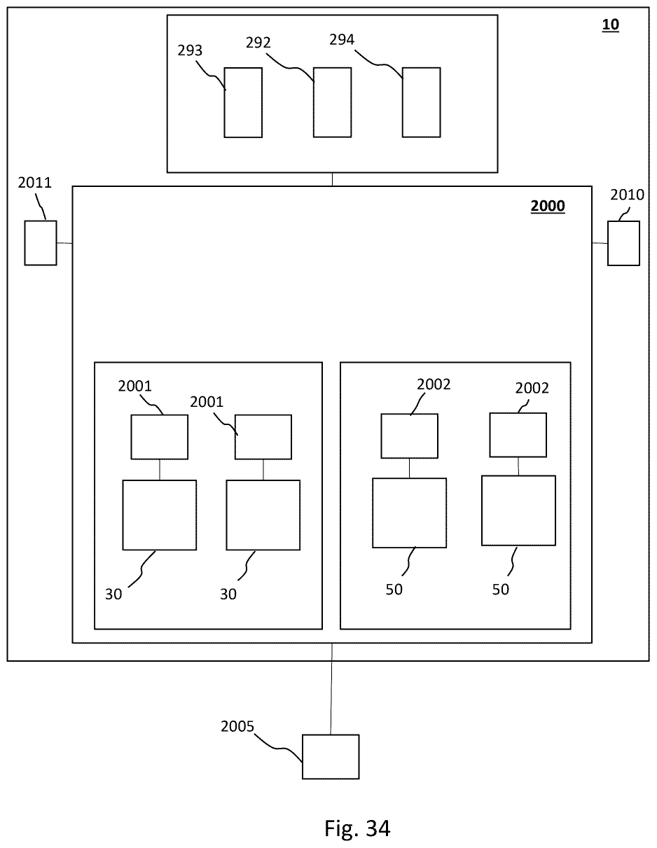

Referencing FIG. 34, a general watercraft 10 according to one example is schematically depicted.

The watercraft 10 may comprise a control system 2000. The control system 2000 may be configured to control the operation of the watercraft 10. The control system 2000 may be configured to be operatively connected to the one or more driveline modules 30 and the one or more electric power modules 50.

The one or more controlling units 293, 294 may be operatively connected to the control system 2000 to enable data communication between the one or more controlling units 293, 294 and the control system 2000. The data communication between the components of the control system 2000 and the data communication between the control system 2000 and other components of the watercraft 10 may be provided by means of wired or wireless communication.

The wired communication may be provided by means of a Central Area Network (CAN) or any other conventional mean of wired communication.

Wireless communication may be established by means of short-range or long-range communication interfaces based on IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, any other form of proximity-based device-to-device radio communication signal such as LTE Direct, W-CDMA/HSPA, GSM, UTRAN, or LTE.

The control system 2000 is configured for performing different functions of the watercraft 10. The control system 2000 may be implemented using instructions that enable hardware functionality, for example, by using computer program instructions executable in a general-purpose or special-purpose processor that may be stored on a computer-readable storage medium (disk, memory, etc.) to be executed by such a processor. The control system 2000 is configured to read the instructions in the memory and execute these instructions to control the operation of the watercraft 10. The control system 2000 may be implemented in any known controller technology, including but not limited to microcontroller, processor (e.g. PLC, CPU, DSP), FPGA, ASIC or any other suitable digital and/or analog circuitry capable of performing the intended functionality. The memory may be implemented in any known memory technology, including but not limited to E(E)PROM, S(D)RAM or flash memory. In some embodiments, the memory may be integrated with or internal to the control system 2000.

The control system 2000 may comprises one or more power controller 2002. The power controller may be configured to control at least one of the one or more electric power modules. In one example, one power controller 2002 may be configured to control a plurality of electric power modules 50. In one example, the power controller 2002 may be provided as a stand-alone module. In one example, the power controller 2002 may be integrated in the connection module 280.

In one example, each electric power module 50 is configured to be controlled by one power controller 2002. In one example, the power controller 2002 may be integrated in the electric power module 50. In one example, each electric power module 50 may be provided with a power controller 2002. Thus, each power controller 2002 may be integrated in an electric power module 50 of the watercraft 10.

The control system 2000 may comprise one or more drive controllers 2001. The one or more drive controllers 2001 may be configured to control at least one of the driveline modules 30. In one example, one drive controller 2001 may be configured to control a plurality of driveline modules 30.

In one example, the drive controller 2001 may be provided as a stand-alone module.

In one example, the drive controller may be integrated in the connection module 280.

In one example, each driveline module 30 is configured to be controlled by one drive controller 2001. In one example, the drive controller 2001 may be integrated in the driveline module 30. In one example, each driveline module 30 may be provided with a drive controller 2001. Thus, each drive controller 2001 may be integrated in a driveline module 30 of the watercraft 10.

In one example, at least one of the one or more drive controllers 2001 may be disposed in one of the one or more mast 202. The mast 202 may thus comprise a hollow space for receiving the drive controller 2001.

Advantageously, the driveline module 30 may be connected to the mast 202, whereby the drive controller 2001 configured to control the driveline module 30 may be disposed in the mast 202.

In one example each drive controller 201 may be disposed in a mast 202.

In one example, at least one of the one or more drive controllers 2001 may be disposed in one of the driveline modules 30.

In one example, at least one of the one more drive controllers 2001 may be disposed adjacent to the underside of the hull module 20.

Preferably, the one or more drive controllers 2001 may comprise an electronic speed controller (ESC). The electronic speed controller may be configured to control the speed of the at least one motor 31 of the driveline module 30.

The control system 2000 may be configured to independently control the speed of the at least one first driveline module 30 and the at least one second driveline module 30. The one or more drive controllers 2001 may be configured to independently control the speed of the at least one first driveline module 30 and the at least one second driveline module 30.

Advantageously, the control system 2000 is configured to obtain the user input data from the user interface of the one or more controlling units 293, 294 and cause control of the one or more driveline modules 30 based on said user input data.

Preferably, the control system 2000 is configured to obtain the user input data from the first controlling unit 293 and cause control of the speed of the at least one first driveline module 30 based on said user input data. The control system 2000 may be configured to obtain the user input data from the second controlling unit 294 and cause control of the speed of the at least one second driveline module 30 based on said user input data.

Preferably, the control system 2000 is configured to obtain the user input data from the first controlling unit 293 and cause control of the speed of the at least one first driveline module 30 based on said user input data by means of one or more drive controller configured to control the speed of said at least one first driveline module. Preferably, the control system 2000 is configured to obtain the user input data from the second controlling unit 294 and cause control of the speed of the at least one second driveline module 30 based on said user input data by means of the one or more drive controller configured to control the speed of the at least one second driveline module.

In one example, where the steering system comprises the steering element 292, the control system 2000 may be configured to cause control of the speed of the at least one first driveline module 30 and at least one second driveline module 30 based on the position of the steering element 292 and user input data from one controlling unit 293. The control system 2000 may be operatively connected to the position sensor configured to obtain steering element positional data associated with the position of the steering element 292. Based on the steering element positional data and the user input data, the control system 2000 may be configured to cause independent control of the speed of the at least one first driveline module and the at least one second driveline module. This may be performed by means of the one or more drive controllers.

Further referencing FIG. 34, the control system 2000 may be configured to obtain control data from an external device 2005 and cause control of the watercraft 10 based on the control data.

Advantageously, the control system 2000 may be configured to obtain the control data from an external device 2005 via a wireless network for controlling the operation of the watercraft 10.

The control data may be obtained from the external device 2005 via short-range or long-range communication interfaces based on IEEE 802.11, IEEE 802.15, ZigBee, WirelessHART, WiFi, Bluetooth®, BLE, RFID, WLAN, MQTT IoT, CoAP, DDS, NFC, AMQP, LoRaWAN, Z-Wave, Sigfox, Thread, EnOcean, mesh communication, any other form of proximity-based device-to-device radio communication signal such as LTE Direct, W-CDMA/HSPA, GSM, UTRAN, or LTE.

The external device 2005 may be a computing device such as a tablet, phone or computer. In one example the external device 2005 may be a remote control.

In one example, the control system 2000 is configured to cause steering and propelling of the watercraft 10 based on the obtained control data.

The control data may comprise location data. The control system 2000 may be configured to cause the watercraft 10 to autonomously travel to a determined location based on said location data.

The watercraft 10 may comprise one or more positional sensing device 2010. The positional sensing device 2010 be a camera, radar or GPS-device, operatively connected to the control system 2000. The positional sensing device 2010 may be configured to acquire positional data associated with the position of the watercraft 10 and/or to acquire data indicating potential obstacles along the route of the watercraft 10.

In one example, the positional sensing device 2010 may comprise a position transmitting device such as a GPS-tracker for determining of the position of the watercraft 10.

The control system 2000 may be configured to cause steering and propelling of the vehicle based on the obtained positional data and/or data indicating potential obstacles along the route of the watercraft 10.

The watercraft 10 may comprise one or more height sensor 2011. The one or more height sensor 2011 may be operatively connected to the control system 2000. The height sensor 2011 may be configured to obtain height data associated with the height of the watercraft 10 relative the water surface. The control system 2000 may be configured to control the operation of the watercraft 10 based on said height data.

According to an aspect a watercraft according to any one of the following clauses is provided.
1. A modular electrically motorized watercraft (10), said watercraft (10) comprising:
   a hull module (20) and a driveline system,
   said driveline system comprising one or more electric power modules (50) and one or more driveline modules (30), wherein said one or more driveline modules (30) are configured to be mounted to an underside of the hull module (20),
   wherein said modules (20, 30, 50) constitute independent sub-assemblies in the form of modules which can be assembled to form said watercraft (10).
2. Watercraft (10) according to clause 1, wherein the driveline system comprises two or more driveline modules (30).
3. Watercraft (10) according to clause 1 or 2, wherein the hull module (20) comprises one or more compartments (24), the one or more compartments (24) being adapted to receive at least one of the one or more electric power modules (50).
4. Watercraft (10) according to clause 2 or 3, wherein a first electric power module (50) is connected to a first driveline module (30) to form a first driveline arrangement, and a second electric power module (50) is connected to a second driveline module (30) to form a second driveline arrangement.
5. Watercraft (10) according to any one of the preceding clauses, wherein at least one of the driveline modules (30) comprises a jet drive (31) for propelling the watercraft (10).
6. Watercraft (10) according to any one of the preceding clauses, wherein the at least one of the driveline modules (30) comprises a propeller drive for propelling the watercraft (10).
7. Watercraft (10) according to any one of the preceding clauses, further comprising one or more hydrofoil arrangements (200) connected to the hull module (20) and configured to be arranged below the underside of the hull module (20).
8. Watercraft (10) according to clause 7, wherein the one or more driveline modules (30) are adapted to be mounted to said one or more hydrofoil arrangements (200).
9. Watercraft (10) according to clause 7 or 8, wherein at least one of the one or more hydrofoil arrangements (200) comprises one or more masts (202) connecting a hydrofoil portion of the hydrofoil arrangement (200) to the hull body (20).
10. Watercraft (10) according to clause 9, wherein the hydrofoil portion of the at least one of the one or more hydrofoil arrangements (200) comprises at least one hydrofoil wing (201, 203, 204).
11. Watercraft (10) according to any one of clause 7 to 10, wherein at least one of the one or more hydrofoil arrangements (200) is detachably connected to the hull module (20).
12. Watercraft (10) according to any one of clause 9 to 11, wherein at least one of the one or more masts (202) is connected to the hull module (20) by means of a pivot connection (280) such that said at least one mast (202) is movable relative the hull module (20) between a deployed position and a stowed away position.
13. Watercraft (10) according to any one of clause 9 to 12, wherein the one or more mast (202) of at least one of the one or more hydrofoil arrangements (200) is adjustably connected to the hull module (20) such that the distance between the hydrofoil portion of the hydrofoil arrangement (200) and the hull module (20) is adjustable.
14. Watercraft (10) according to any one of clause 7 to 13, wherein the driveline modules (30) comprises a connection interface adapted to be mountable both directly to the hull module (20) and to the one or more hydrofoil arrangements (200).
15. Watercraft (10) according to clause 7 to 14, wherein at least one of the one or more hydrofoil arrangement (200) comprises a hydrofoil wing (950) directly mounted to the hull module (20).
16. Watercraft (10) according to clause 15, wherein the one or more driveline modules (30) are adapted to be mounted directly to the hull module (20).
17. Watercraft (10) according to clause 16, wherein the one or more driveline modules (30) are arranged at a rear portion of the hull module (20) and the hydrofoil wing (950) is arranged at a front portion of the hull module (20).
18. Watercraft (10) according to any one of clause 7 to 17, wherein at least one of the one or more hydrofoil arrangements (200) comprises a movable wing (209) connected to a regulating member (229) for regulating the position of the movable wing (209).
19. Watercraft (10) according to any one of the preceding clauses, wherein the hull module (20) further comprises an outboard connection arrangement (921) adapted to provide a releasable mounting for one or more outboard propeller motor system or outboard jet motor system (920) for propelling the watercraft (10).
20. Watercraft (10) according to any one of the preceding clauses, wherein the driveline system is operable independently from the hull module (20).
21. Watercraft (10) according to any one of the preceding clauses, wherein the hull module (20) forms any one of a flat hull, a catamaran hull, a trimaran hull or a V-shaped hull.
22. Watercraft (10) according to any one of the preceding clauses, further comprising a seating portion (210) for accommodating a seated driver of the watercraft (10).
23. Watercraft (10) according to clause 22, further comprising an operations module (250) adapted to be detachably mounted to the hull module (20), the operations module (250) comprising the seating portion (210).
24. Watercraft (10) according to clause 23, wherein the operations module (250) comprises a handle (681, 682) for accessing the watercraft (10) from the water.
25. Watercraft (10) according to any one of clause 22 to 24, further comprising a support structure (600) adapted to connect the hull module (20) and the seating portion (210), the support structure (600) being adapted to provide a distance between an upper seating surface of the seating portion (210) and the hull module (20).
26. Watercraft (10) according to clause 25, wherein the support structure (600) is adjustable between a first position wherein the seating portion (210) is elevated relative the hull module (20) and a second position wherein the seating portion (210) is lowered relative the hull module (20).
27. Watercraft (10) according to any one of the preceding clauses, wherein the hull module (20) extends along a longitudinal center axis (C) and the one or more driveline modules (30) comprises at least one first driveline module (30) arranged on a first side of the longitudinal center axis (C) and at least one second driveline module (30) arranged on a second side of the longitudinal center axis (C).
28. Watercraft (10) according to any one of the preceding clauses, wherein the watercraft (10) is configured to be steerable by means of the body weight of a user.
29. Watercraft (10) according to clause 27 or 28, wherein the watercraft (10) is configured to be steerable by means of individual speed control of the driveline modules (30).
30. Watercraft (10) according to any one of the preceding clauses, further comprising one or more controlling units (293, 294) configured to cause control of the speed of the one or more driveline modules (30) based on user input data obtained from a user interface of said one or more controlling units (293, 294).
31. Watercraft (10) according to clause 30 when dependent on claim 29, further comprising a first controlling unit (293) configured to cause control of the speed of the at least one first driveline module (30) based on obtained from the user interface of the first controlling unit (293) and a second controlling unit (294) configured to control the speed of the at least one second driveline module (30) based on user input data obtained from the user interface of the second controlling unit (294).
32. Watercraft (10) according to clause 30 or 31, further comprising a steering element (292), whereby the one or more controlling unit (293, 294) and the steering element (292) are configured to cause individual control of the speed of the at least one first driveline module (30) and the at least one second driveline module (30) based on the user input data obtained from the user interface of the controlling unit (293, 294) and the position of the steering element (292).
33. Watercraft (10) according to clause 32, wherein the steering element (292) is detachable and the driveline system is operable without said steering element (292).
34. Watercraft (10) according to any one of the preceding clauses, further comprising a control system (2000) configured to control the operation of the watercraft (10) and to be operatively connected to the one or more driveline modules (30) and the one or more electric power modules (50).
35. Watercraft (10) according to clause 34, wherein the one or more controlling units (293, 294) are operatively connected to the control system (2000) to enable data communication between the one or more controlling units (293, 294) and the control system (2000).
36. Watercraft (10) according to clause 34 or 35, wherein the control system (2000) comprises one or more power controller (2002), wherein the power controller (2002) is configured to control at least one of the one or more electric power modules (50).
37. Watercraft (10) according to claim to any one of clauses 32 to 36, wherein the control system (2000) comprises one or more drive controllers (2001), wherein the drive controller (2001) is configured to control at least one of the one or more driveline modules (30).
38. Watercraft (10) according to clause 37, wherein at least one of the one or more drive controllers (2001) is disposed in one of the one or more mast (202).
39. Watercraft (10) according to clause 37, wherein at least one of the one or more drive controllers (2001) is disposed in one of the one or more driveline modules ( ).
40. Watercraft (10) according to any one of clause 37 to 39, wherein at least one of the one more drive controllers (2001) is disposed adjacent to the underside of the hull module (20).
41. Watercraft (10) according to any one of clause 34 to 40, wherein the control system (2000) is configured to obtain control data from an external device (2005) and cause control of the watercraft (10) based on the control data.
42. Watercraft (10) according to clause 41, wherein the control system (2000) is configured to obtain the control data from an external device (2005) via a wireless network for controlling the operation of the watercraft (10).
43. Watercraft (10) according to clause 42, wherein the control system (2000) is configured to cause steering and propelling of the watercraft (10) based on the obtained control data.
44. Watercraft (10) according to clause 42 or 43, wherein the control data comprises location data and the control system (2000) is configured to cause the watercraft (10) to autonomously travel to a determined location based on said location data.
45. Watercraft (10) according to any one of clause 34 to 44, further comprising one or more positional sensing device (2010), such as a camera, radar or GPS-device, operatively connected to the control system (2000) and configured to acquire positional data associated with the position of the watercraft (10) and/or to acquire data indicating potential obstacles along the route of the watercraft (10).
46. Watercraft (10) according to clause 45, wherein the control system (2000) is configured to cause steering and propelling of the vehicle based on the obtained positional data and/or data indicating potential obstacles along the route of the watercraft (10).
47. Watercraft (10) according to any one of clause 34 to 46, further comprising one or more height sensor (2011) operatively connected to the control system (2000) and configured to obtain height data associated with the height of the watercraft (10) relative the water surface, whereby the control system (2000) is configured to control the operation of the watercraft (10) based on said height data.
48. Watercraft (10) according to any one of the preceding clauses, comprising a handle (681, 682) for accessing the watercraft (10) from the water.
49. Watercraft (10) according to any one of clause 25 to 49, wherein the support structure (600) is adapted to connect the operations module (250) and the hull module (20), whereby the support structure (600) is releasably connected to the operations module (250) and/or the hull module (20).
50. Watercraft (10) according to any one of clause 27 to 49, wherein the watercraft (10) is configured to be steerable by means of individual speed control of the at least one driveline module (30) and the at least one second driveline module (30).
51. Watercraft (10) according to any one of clause 32 to 50, wherein the steering element (292) is detachably mounted to the operations module (250).
52. Watercraft (10) according to any one of clause 30 to 51, wherein the one or more controlling units (293, 294) are arranged on the operations module (250).
53. Watercraft (10) according to any one of the preceding clauses, wherein the hull module (20) comprises at least one inflatable hull component.
54. Watercraft (10) according to clause 53, wherein the hull module (20) comprises a rigid support structure and the at least one inflatable hull component is connected to said rigid support structure.
55. Watercraft (10) according to any one of clause 7 to 54, wherein the one or more hydrofoil arrangements (200) are configured to cause the watercraft (10) to enter a semi-hydrofoiling state wherein a portion of the outer surface of the hull module (20) is in contact with the water surface during operation in the water, from a normal operational state as the speed of the watercraft (10) increases, and wherein the portion of the outer surface of the hull module (20) being in contact with the water is smaller for the semi-hydrofoiling state compared to the normal operational state.
56. Watercraft (10) according to clause 55, wherein at least one of the one or more hydrofoil arrangements (200) comprises one or more masts (202) connecting a hydrofoil portion of the hydrofoil arrangement (200) to the hull body (20) and said one or more masts (202) are adapted to enable the semi-hydrofoiling state.
57. Watercraft (10) according to clause 55 or 56, wherein the one or more hydrofoil arrangements (200) are configured to maintain the watercraft (10) in the semi-hydrofoiling state when the watercraft (10) is operated at a travelling speed corresponding to the maximum operating speed of the one or more driveline modules (30).
58. Watercraft (10) according to any one of clause 7 to 54, wherein the one or more hydrofoil arrangements (200) are configured to cause the watercraft (10) to enter a fully hydrofoiling state wherein the hull module (20) is not in contact with the water surface during operation in the water, from a normal operational state as the speed of the watercraft (10) increases.
59. Watercraft (10) according to clause 58, wherein at least one of the one or more hydrofoil arrangements (200) comprises one or more masts (202) connecting a hydrofoil portion of the hydrofoil arrangement (200) to the hull body (20) and said one or more masts (202) are adapted to enable the fully hydrofoiling state.

It should be appreciated that examples of the disclosure are generally combinable unless specified.

The invention has mainly been described above with reference to a few embodiments. However, as is readily appreciated by a person skilled in the art, other embodiments than the ones disclosed above are equally possible within the scope of the invention, as defined by the appended patent claims.

1. A modular electrically motorized watercraft, the watercraft comprising:
a hull module and a driveline system;
the driveline system including one or more electric power modules and two or more driveline modules;
wherein the two or more driveline modules are configured to be mounted to an underside of the hull module;
wherein the hull module, the one or more electric power modules, and the two or more driveline modules constitute independent sub-assemblies that form the watercraft when assembled together.

2.-18. (canceled)

19. The watercraft according to claim 1, wherein the driveline system is operable independently from the hull module.

20.-22. (canceled)

23. The watercraft according to claim 1, wherein the hull module extends along a longitudinal center axis and the driveline modules comprise at least one first driveline module arranged on a first side of the longitudinal center axis and at least one second driveline module arranged on a second side of the longitudinal center axis.

24. The watercraft according to claim 1, wherein the watercraft is configured to be steerable by means of the body weight of a user.

25. The watercraft according to claim 1, wherein the watercraft is configured to be steerable by means of individual speed control of the driveline modules.

26. The watercraft according to claim 1, further comprising one or more controlling units configured to cause control of the speed of the driveline modules based on user input data obtained from a user interface of the one or more controlling units.

27. The watercraft according to claim 26, further comprising:
a first controlling unit configured to cause control of the speed of at least one first driveline module based on user input data obtained from the user interface of the first controlling unit; and
a second controlling unit configured to control the speed of at least one second driveline module based on user input data obtained from the user interface of the second controlling unit.

28. The watercraft according to claim 26, further comprising a steering element, whereby the one or more controlling units and the steering element are configured to cause individual control of the speed of at least one first driveline module and at least one second driveline module based on the user input data obtained from the user interface of the controlling unit and a position of the steering element.

29. The watercraft according to claim 28, wherein the steering element is detachable and the driveline system is operable without the steering element.

30. The watercraft according to claim 1, further comprising a control system configured to control the operation of the watercraft and to be operatively connected to the driveline modules and the one or more electric power modules.

31. The watercraft according to claim 30, further comprising:
one or more controlling units configured to cause control of the speed of the driveline modules based on user input data obtained from a user interface of the one or more controlling units;
wherein the one or more controlling units are operatively connected to the control system to enable data communication between the one or more controlling units and the control system.

32. The watercraft according to claim 30, wherein the control system comprises one or more power controllers, wherein each power controller is configured to control at least one of the one or more electric power modules.

33. The watercraft according to claim 30, wherein the control system comprises one or more drive controllers, wherein the one or more drive controllers are configured to control at least one of the driveline modules.

34.-36. (canceled)

37. The watercraft according to claim 30, wherein the control system is configured to obtain control data from an external device and cause control of the watercraft based on the control data.

38. The watercraft according to claim 37, wherein the control system is configured to obtain the control data from the external device via a wireless network for controlling the operation of the watercraft.

39. The watercraft according to claim 38, wherein the control system is configured to cause steering and propelling of the watercraft based on the obtained control data.

40. The watercraft according to claim 38, wherein the control data comprises location data and the control system is configured to cause the watercraft to autonomously travel to a determined location based on the location data.

41. The watercraft according to claim 30, further comprising one or more positional sensing devices, operatively connected to the control system and configured to acquire positional data associated with the position of the watercraft and/or to acquire data indicating potential obstacles along a route of the watercraft.

42. The watercraft according to claim 41, wherein the control system is configured to cause steering and propelling of the watercraft based on the obtained positional data and/or data indicating potential obstacles along the route of the watercraft.

43. The watercraft according to claim 30, further comprising one or more height sensors operatively connected to the control system and configured to obtain height data associated with a height of the watercraft relative to the water surface, whereby the control system is configured to control the operation of the watercraft based on the height data.
